(19) United States
(12) Patent Application Publication
(10) Pub. No.: US 2026/0230348 A1
(43) Pub. Date: Aug. 6, 2026

(54) CHANNEL GRANULARITY FOR FREQUENCY MODULATED CONTINUOUS WAVEFORM-BASED CHANNEL ESTIMATION

(71) Applicant: QUALCOMM Incorporated, San Diego, CA (US)

(72) Inventors: Kangqi LIU, San Diego, CA (US); Danlu ZHANG, San Diego, CA (US); Weimin DUAN, San Diego, CA (US); Jing DAI, Beijing (CN)

(21) Appl. No.: 19/158,313

(22) PCT Filed: Apr. 21, 2023
(86) PCT No.: PCT/CN2023/089669

§ 371 Date: Aug. 20, 2025

(51) Int. Cl. H04L 25/02; H04B 7/06

(52) U.S. Cl. CPC H04L 25/0202; H04B 7/0626

(57) ABSTRACT

Methods, systems, and devices for wireless communications are described. Some wireless communications systems may support frequency modulated continuous waveform (FMCW)-based channel estimation. A network entity may transmit, to a user equipment (UE), a trigger for an FMCW-based channel estimation procedure. The network entity may transmit an FMCW signal to the UE via a channel based on the trigger. The UE may estimate the channel, responsive to the trigger, with a subband granularity as part of the FMCW-based channel estimation procedure. The UE may estimate the channel based on the FMCW signal, a measured delay associated with the channel, and a measured Doppler-based frequency shift associated with the channel. The UE may transmit a channel estimation report including one or more channel parameters associated with the subband granularity and based on the estimation.

### CROSS REFERENCE

The present application is a 371 national phase filing of International PCT Application No. PCT/CN2023/089669 by LIU et al., entitled “CHANNEL GRANULARITY FOR FREQUENCY MODULATED CONTINUOUS WAVEFORM-BASED CHANNEL ESTIMATION,” filed Apr. 21, 2023, which is assigned to the assignee hereof, and which is expressly incorporated by reference in its entirety herein.

### FIELD OF TECHNOLOGY

The following relates to wireless communication, including channel granularity for frequency modulated continuous waveform (FMCW)-based channel estimation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some systems, a network entity may transmit a frequency modulated continuous waveform (FMCW) signal to a UE. The FMCW signal may convey information and may be characterized by a varying (e.g., increasing) transmit frequency over the time domain according to a slope during a symbol duration of the signal. Some UEs may perform channel estimation based on the FMCW signal.

### SUMMARY

The described techniques relate to improved methods, systems, devices, and apparatuses that support channel granularity for frequency modulated continuous waveform (FMCW)-based channel estimation. For example, the described techniques provide for a user equipment (UE) to account for and reduce potential errors during a channel estimation procedure that is based on an FMCW signal. FMCW-based channel estimation may be associated with reduced processing and complexity as compared with other types of channel estimation. For example, the UE may estimate a wideband channel using a narrowband baseband. However, to further reduce potential channel estimation error that may be based on a subband reporting granularity, based on one or more FMCW characteristics, such as delay spread, or both, a UE as described herein may perform the channel estimation based on measurements of a delay associated with the channel, a Doppler-based frequency shift associated with the channel, or both. A network entity may transmit, to the UE, a trigger for an FMCW-based channel estimation procedure by the UE. The trigger may indicate a subband granularity for the channel estimation procedure, or may request that the UE selects a subband granularity. The network entity may transmit an FMCW signal to the UE via a channel based on the trigger. The UE may estimate the channel as part of the FMCW-based channel estimation procedure and in accordance with the subband granularity. The UE may estimate the channel based on the FMCW signal, a measured delay associated with the channel, and a measured Doppler-based frequency shift associated with the channel. For example, the UE may select the subband granularity based on the measurements, or the UE may determine a type of channel estimation to perform based on the subband granularity and the measurements, or both. The UE may transmit a channel estimation report including one or more channel parameters associated with the subband granularity and based on the estimation.

A method for wireless communication at a UE is described. The method may include receiving a control message including a trigger for an FMCW-based channel estimation procedure, receiving, via a channel, an FMCW signal, estimating the channel, responsive to the trigger, with a subband granularity as part of the FMCW-based channel estimation procedure, estimation of the channel based on the FMCW signal, a measured delay associated with the channel, and a measured Doppler-based frequency shift associated with the channel, and transmitting a channel estimation report including a set of one or more channel parameters determined via the estimation of the channel, the channel estimation report associated with the subband granularity.

An apparatus for wireless communication at a UE is described. The apparatus may include a processor, memory coupled with the processor, and instructions stored in the memory. The instructions may be executable by the processor to cause the apparatus to receive a control message including a trigger for an FMCW-based channel estimation procedure, receive, via a channel, an FMCW signal, estimate the channel, responsive to the trigger, with a subband granularity as part of the FMCW-based channel estimation procedure and in accordance with a subband granularity, estimation of the channel based on the FMCW signal, a measured delay associated with the channel, and a measured Doppler-based frequency shift associated with the channel, and transmit a channel estimation report including a set of one or more channel parameters determined via the estimation of the channel, the channel estimation report associated with the subband granularity.

Another apparatus for wireless communication at a UE is described. The apparatus may include means for receiving a control message including a trigger for an FMCW-based channel estimation procedure, means for receiving, via a channel, an FMCW signal, means for estimating the channel, responsive to the trigger, with a subband granularity as part of the FMCW-based channel estimation procedure, estimation of the channel based on the FMCW signal, a measured delay associated with the channel, and a measured Doppler-based frequency shift associated with the channel, and means for transmitting a channel estimation report including a set of one or more channel parameters determined via the estimation of the channel, the channel estimation report associated with the subband granularity.

A non-transitory computer-readable medium storing code for wireless communication at a UE is described. The code may include instructions executable by a processor to receive a control message including a trigger for an FMCW-based channel estimation procedure, receive, via a channel, an FMCW signal, estimate the channel, responsive to the trigger, with a subband granularity as part of the FMCW-based channel estimation procedure, estimation of the channel based on the FMCW signal, a measured delay associated with the channel, and a measured Doppler-based frequency shift associated with the channel, and transmit a channel estimation report including a set of one or more channel parameters determined via the estimation of the channel, the channel estimation report associated with the subband granularity.

Some examples of the method, apparatuses, and non-transitory computer-readable medium described herein may further include operations, features, means, or instructions for transmitting, via the channel estimation report, an indication of the subband granularity, where the subband granularity is selected from among a set of candidate subband granularities, and where the set of candidate subband granularities may be based on the measured delay and the measured Doppler-based frequency shift.

Some examples of the method, apparatuses, and non-transitory computer-readable medium described herein may further include operations, features, means, or instructions for calculating a threshold subband size based on a function of the measured delay and the measured Doppler-based frequency shift, where the subband granularity corresponds to a frequency subband size associated with the channel estimation report, and where the set of candidate subband granularities includes frequency subband sizes that may be greater than or equal to the threshold subband size.

Some examples of the method, apparatuses, and non-transitory computer-readable medium described herein may further include operations, features, means, or instructions for calculating a threshold quantity of subbands based on a function of the measured delay and the measured Doppler-based frequency shift, where the subband granularity corresponds to a quantity of frequency subbands associated with the channel estimation report, and where the set of candidate subband granularities includes quantities of frequency subbands that may be less than or equal to the threshold quantity.

Some examples of the method, apparatuses, and non-transitory computer-readable medium described herein may further include operations, features, means, or instructions for receiving a control message that indicates the set of candidate subband granularities.

Some examples of the method, apparatuses, and non-transitory computer-readable medium described herein may further include operations, features, means, or instructions for receiving a control message that indicates the set of candidate subband granularities from among a set of multiple defined sets of subband granularities.

Some examples of the method, apparatuses, and non-transitory computer-readable medium described herein may further include operations, features, means, or instructions for receiving a control message that indicates the subband granularity for the FMCW-based channel estimation procedure by the UE and comparing, based on the control message, the measured delay associated with the channel with a channel estimation error parameter, where a value of the channel estimation error parameter may be based on the subband granularity and the measured Doppler-based frequency shift associated with the channel, and where estimating the channel may be based on the comparing.

In some examples of the method, apparatuses, and non-transitory computer-readable medium described herein, estimating the channel may include operations, features, means, or instructions for estimating the channel in accordance with a sampling rate based on the measured delay being less than or equal to the value of the channel estimation error parameter.

In some examples of the method, apparatuses, and non-transitory computer-readable medium described herein, estimating the channel may include operations, features, means, or instructions for estimating, based on the measured delay being greater than the value of the channel estimation error parameter, the channel on a per-tap basis for each tap of a set of taps associated with the FMCW signal, where each tap of the set of taps corresponds to a unique channel delay associated with the FMCW signal.

Some examples of the method, apparatuses, and non-transitory computer-readable medium described herein may further include operations, features, means, or instructions for transmitting a message that indicates a second subband granularity different than the subband granularity, where the control message indicates an adjustment to the subband granularity from the second subband granularity.

Some examples of the method, apparatuses, and non-transitory computer-readable medium described herein may further include operations, features, means, or instructions for communicating in accordance with the subband granularity and the set of one or more channel parameters indicated via the channel estimation report.

In some examples of the method, apparatuses, and non-transitory computer-readable medium described herein, transmitting the channel estimation report may include operations, features, means, or instructions for transmitting a channel state information (CSI) report that indicates the set of one or more channel parameters.

A method for wireless communication at a network entity is described. The method may include transmitting a control message including a trigger for an FMCW-based channel estimation procedure, transmitting, via a channel, an FMCW signal, and receiving, based on the FMCW-based channel estimation procedure, a channel estimation report including a set of one or more channel parameters, the channel estimation report associated with a subband granularity, where the channel estimation report is based on the FMCW signal, a measured delay associated with the channel, and a measured Doppler-based frequency shift associated with the channel.

An apparatus for wireless communication at a network entity is described. The apparatus may include a processor, memory coupled with the processor, and instructions stored in the memory. The instructions may be executable by the processor to cause the apparatus to transmit a control message including a trigger for an FMCW-based channel estimation procedure, transmit, via a channel, an FMCW signal, and receive, based on the FMCW-based channel estimation procedure, a channel estimation report including a set of one or more channel parameters, the channel estimation report associated with a subband granularity, where the channel estimation report is based on the FMCW signal, a measured delay associated with the channel, and a measured Doppler-based frequency shift associated with the channel.

Another apparatus for wireless communication at a network entity is described. The apparatus may include means for transmitting a control message including a trigger for an FMCW-based channel estimation procedure, means for transmitting, via a channel, an FMCW signal, and means for receiving, based on the FMCW-based channel estimation procedure, a channel estimation report including a set of one or more channel parameters, the channel estimation report associated with a subband granularity, where the channel estimation report is based on the FMCW signal, a measured delay associated with the channel, and a measured Doppler-based frequency shift associated with the channel.

A non-transitory computer-readable medium storing code for wireless communication at a network entity is described. The code may include instructions executable by a processor to transmit a control message including a trigger for an FMCW-based channel estimation procedure, transmit, via a channel, an FMCW signal, and receive, based on the FMCW-based channel estimation procedure, a channel estimation report including a set of one or more channel parameters, the channel estimation report associated with a subband granularity, where the channel estimation report is based on the FMCW signal, a measured delay associated with the channel, and a measured Doppler-based frequency shift associated with the channel.

Some examples of the method, apparatuses, and non-transitory computer-readable medium described herein may further include operations, features, means, or instructions for receiving, via the channel estimation report, an indication of the subband granularity based on the measured delay and the measured Doppler-based frequency shift.

In some examples of the method, apparatuses, and non-transitory computer-readable medium described herein, the subband granularity corresponds to a frequency subband size associated with the channel estimation report.

In some examples of the method, apparatuses, and non-transitory computer-readable medium described herein, the subband granularity corresponds to a quantity of frequency subbands associated with the channel estimation report.

Some examples of the method, apparatuses, and non-transitory computer-readable medium described herein may further include operations, features, means, or instructions for transmitting a control message that indicates a set of candidate subband granularities, where the subband granularity may be selected from the set of candidate subband granularities.

Some examples of the method, apparatuses, and non-transitory computer-readable medium described herein may further include operations, features, means, or instructions for transmitting a control message that indicates a set of candidate subband granularities from among a set of multiple defined sets of subband granularities, where the subband granularity may be selected from the set of candidate subband granularities.

Some examples of the method, apparatuses, and non-transitory computer-readable medium described herein may further include operations, features, means, or instructions for transmitting a control message that indicates the subband granularity for the FMCW-based channel estimation procedure, where the FMCW-based channel estimation procedure may be based on a value of the subband granularity, the measured delay, and the measured Doppler-based frequency shift.

Some examples of the method, apparatuses, and non-transitory computer-readable medium described herein may further include operations, features, means, or instructions for receiving a message that indicates a second subband granularity different than the subband granularity and adjusting the second subband granularity to the subband granularity based on one or more parameters associated with the channel, where the control message indicates the subband granularity based on the adjusting.

Some examples of the method, apparatuses, and non-transitory computer-readable medium described herein may further include operations, features, means, or instructions for communicating in accordance with the subband granularity and the set of one or more channel parameters indicated via the channel estimation report.

In some examples of the method, apparatuses, and non-transitory computer-readable medium described herein, receiving the channel estimation report may include operations, features, means, or instructions for receiving a CSI report that indicates the set of one or more channel parameters.

### BRIEF DESCRIPTION OF THE DRAWINGS

FIG. 1 shows an example of a wireless communications system that supports channel granularity for frequency modulated continuous waveform (FMCW)-based channel estimation in accordance with one or more aspects of the present disclosure.

FIG. 2 shows an example of a channel estimation scheme that supports channel granularity for FMCW-based channel estimation in accordance with one or more aspects of the present disclosure.

FIGS. 3A and 3B show examples of frequency estimation diagrams that support channel granularity for FMCW-based channel estimation in accordance with one or more aspects of the present disclosure.

FIG. 4 shows an example of an FMCW signal that supports channel granularity for FMCW-based channel estimation in accordance with one or more aspects of the present disclosure.

FIG. 5 shows an example of a wireless communications system that supports channel granularity for FMCW-based channel estimation in accordance with one or more aspects of the present disclosure.

FIG. 6 shows an example of a process flow that supports channel granularity for FMCW-based channel estimation in accordance with one or more aspects of the present disclosure.

FIG. 7 shows an example of a process flow that supports channel granularity for FMCW-based channel estimation in accordance with one or more aspects of the present disclosure.

FIG. 8 shows an example of a process flow that supports channel granularity for FMCW-based channel estimation in accordance with one or more aspects of the present disclosure.

FIGS. 9 and 10 show block diagrams of devices that support channel granularity for FMCW-based channel estimation in accordance with one or more aspects of the present disclosure.

FIG. 11 shows a block diagram of a communications manager that supports channel granularity for FMCW-based channel estimation in accordance with one or more aspects of the present disclosure.

FIG. 12 shows a diagram of a system including a device that supports channel granularity for FMCW-based channel estimation in accordance with one or more aspects of the present disclosure.

FIGS. 13 and 14 show block diagrams of devices that support channel granularity for FMCW-based channel estimation in accordance with one or more aspects of the present disclosure.

FIG. 15 shows a block diagram of a communications manager that supports channel granularity for FMCW-based channel estimation in accordance with one or more aspects of the present disclosure.

FIG. 16 shows a diagram of a system including a device that supports channel granularity for FMCW-based channel estimation in accordance with one or more aspects of the present disclosure.

FIGS. 17 through 21 show flowcharts illustrating methods that support channel granularity for FMCW-based channel estimation in accordance with one or more aspects of the present disclosure.

### DETAILED DESCRIPTION

In some wireless communications systems, wireless devices may utilize a frequency modulated continuous waveform (FMCW) signal to convey information. The FMCW may be characterized by a varying (e.g., increasing) transmit frequency over the time domain according to a slope during a symbol duration of the signal. Some networks may perform channel estimation based on the FMCW signal. For example, a user equipment (UE) may estimate an orthogonal frequency division multiplexed (OFDM) channel based on an FMCW signal. Such FMCW-based channel estimation techniques may reduce a sampling rate for the channel estimation as compared with other channel estimation techniques, which may reduce processing and power consumption. The FMCW signal may support wideband channel estimation using a narrowband baseband, which may reduce processing. After performing FMCW-based channel estimation, a UE may report one channel estimation report (e.g., a channel state information (CSI) report) per frequency subband in the channel. However, a relatively large subband may include multiple tones with different channels, which may cause some channel estimation error. Additionally, or alternatively, there may be a channel delay associated with the FMCW signal, which may cause channel estimation error. As such, there may be some tradeoff between subband size and a maximum channel delay spread of FMCW signals for channel estimation.

Techniques, systems, and devices described herein provide for improved FMCW-based channel estimation by using measurements of channel delay and Doppler-based frequency shift to reduce channel estimation error. The FMCW-based channel estimation may be performed in accordance with a subband granularity, which may correspond to a subband size or a quantity of subbands per channel. The subband granularity may be determined by a UE or by a network entity. If the network entity instructs the UE to perform channel estimation based on a received FMCW and select the subband granularity, the UE may measure the FMCW signal and autonomously determine a subband granularity for the channel estimation. The UE may determine the subband granularity based on measurements, by the UE, of channel delay and Doppler-based frequency shift. The UE may calculate a threshold subband granularity based on the measured delay and Doppler-based frequency shift and may select a subband granularity according to the threshold such that a dominant error in the FMCW-based channel estimation may be based on the subband channel reporting granularity (instead of the FMCW-based channel estimation delay), as such error may be negated by the reduced processing provided by FMCW-based channel estimation. The UE may transmit a channel estimation report to indicate one or more channel parameters per subband and the selected subband granularity based on the channel estimation.

In some examples, the network entity may select and indicate the subband granularity to the UE. In such cases, the UE may receive the FMCW signal and measure channel delay and Doppler-based frequency shift associated with the channel. The UE may determine or calculate a channel estimation error parameter based on the measurements and may compare the measured delay with the channel estimation error parameter to determine whether a dominant source of error in the channel estimation is due to the subband CSI reporting granularity or the channel estimation delay. The UE may select a type of channel estimation to perform based on the determined source of error. For example, if the error stems from channel subband reporting granularity, the UE may perform the channel estimation according to a sampling rate and may report the results to the network entity. If the error stems from a delay associated with the FMCW signal, the UE may perform a per-tap phase compensation estimation procedure. The per-tap phase compensation may include the UE estimating the channel on a per-tap basis for a set of taps, where each tap may correspond to a different channel delay associated with the FMCW signal. The UE may thereby account for channel delay and Doppler-based frequency shifts when performing FMCW-based channel estimation, which may improve reliability and reduce latency.

Aspects of the disclosure are initially described in the context of wireless communications systems. Additional aspects of the disclosure are described with reference to a channel estimation scheme, frequency estimation diagrams, an FMCW signal, and process flows. Aspects of the disclosure are further illustrated by and described with reference to apparatus diagrams, system diagrams, and flowcharts that relate to channel granularity for FMCW-based channel estimation.

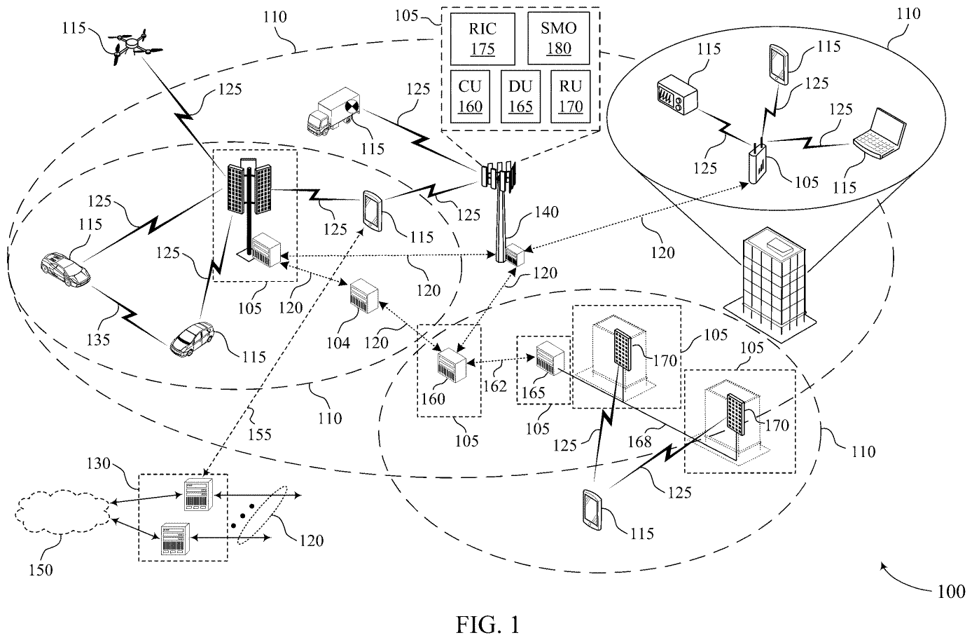

FIG. 1 shows an example of a wireless communications system 100 that supports channel granularity for FMCW-based channel estimation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support channel granularity for FMCW-based channel estimation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 MHz to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A waveform and multiple-access design that is used for wireless communications may be configured to support a relatively wide variety of use cases, such as mobile broadband, metaverse, massive internet-of-things (IoT), sidelink, massive spectrum aggregation or duplex, UE cooperation, other use cases, or any combination thereof. In some examples, the waveform and multiple-access design may support a relatively large variety of technologies, such as full duplex technologies, radio frequency sensing, positioning, physical layer security, other technologies, or any combination thereof. Additionally, or alternatively, the waveform and multiple-access design may be supported across multiple frequency ranges and bands (e.g., mmW and beyond) as the use cases and technologies (e.g., radio frequency, MIMO, and duplexing technologies, among other types) expand. In some examples, the waveform and multiple-access design may be configured to support relatively large amounts of connectivity and relatively high cell capacity (e.g., the waveform and multiple-access design may provide relatively efficient support for channel access for a relatively high quantity of users).

One or more waveforms used for wireless communications may be based on multiple design metrics. The design metrics may include, for example, spectrum efficiency, energy efficiency (e.g., power amplifier and processing power efficiency at transmitting and receiving devices, respectively), waveform processing complexity and latency, radio frequency impairments (e.g., error vector magnitude (EVM), or the like), spectrum confinement with a power amplifier model (e.g., in-band and out-of-band emissions), and support for relatively efficient multi-user or MIMO multiple-access. The one or more waveforms may be designed to support one or more channel conditions, such as fading (e.g., time variation or inter-symbol-interference (ISI)), phase noise, power amplifier nonlinearities, or any combination thereof. In some examples, the one or more waveforms may be designed based on digital pre-distortion (DPD) and digital post-distortion (DPoD) technology advancements, spectrum confinement for full duplex, joint sensing and common (JSAC) use cases, or any combination thereof.

A UE 115 as described herein may account for and reduce potential error during a channel estimation procedure based on an FMCW. The FMCW-based channel estimation may be associated with reduced processing and complexity as compared with other types of channel estimation. For example, the UE 115 may estimate a wideband channel using a narrowband baseband. However, to further reduce potential channel estimation error that may be based on a subband reporting granularity, based on one or more FMCW characteristics, such as delay spread, or both, a UE 115 as described herein may perform the channel estimation based on measurements of a delay associated with the channel, a Doppler-based frequency shift associated with the channel, or both. A network entity 105 may transmit, to the UE 115, a trigger for an FMCW-based channel estimation procedure 115. The trigger may indicate a subband granularity for the channel estimation procedure, or may request that the UE 115 selects a subband granularity. The network entity 105 may transmit an FMCW signal to the UE 115 via a channel based on the trigger. The UE 115 may estimate the channel, responsive to the trigger, with a subband granularity as part of the FMCW-based channel estimation procedure and in accordance with the subband granularity. The UE 115 may estimate the channel based on the FMCW signal, a measured delay associated with the channel, and a measured Doppler-based frequency shift associated with the channel. For example, the UE 115 may select the subband granularity based on the measurements, or the UE 115 may determine a type of channel estimation to perform based on the subband granularity and the measurements, or both. The UE 115 may transmit a channel estimation report including one or more channel parameters associated with the subband granularity and based on the estimation.

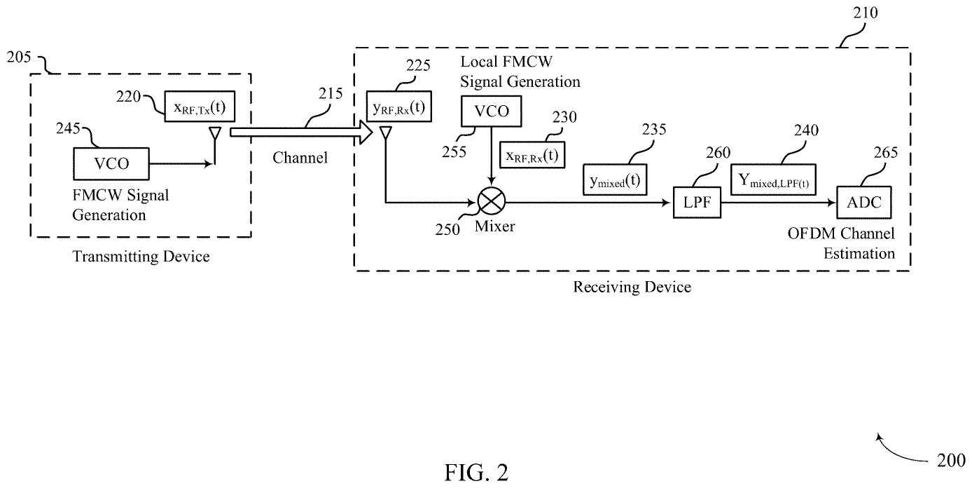

FIG. 2 shows an example of a channel estimation scheme 200 that supports channel granularity for FMCW-based channel estimation in accordance with one or more aspects of the present disclosure. The channel estimation scheme 200 may implement aspects of the wireless communications system 100 described with reference to FIG. 1. In this example, a transmitting device 205 (e.g., a UE, a base station, an RU, a DU, a CU, an IAB node or some other device) and a receiving device 210 (e.g., a UE, a base station, an RU, a DU, a CU, an IAB node or some other device) may exchange an FMCW signal via a channel 215. The FMCW signal may be used to facilitate time domain channel estimation of the frequency domain channel by the receiving device 210.

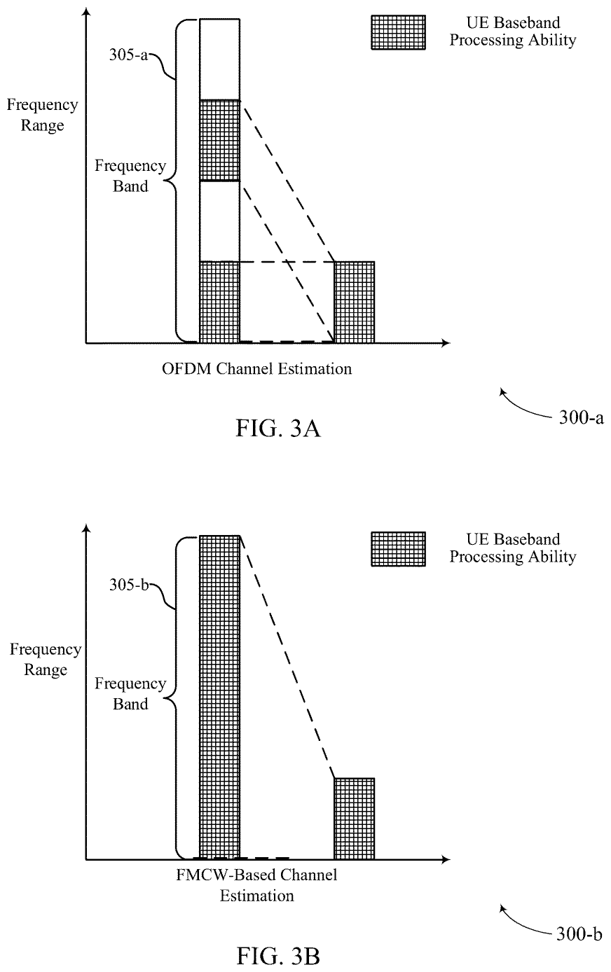

The transmitting device 205 and the receiving device 210 may establish a connection for wireless communications via the channel 215. The channel 215 may be an OFDM channel, in some examples. The devices may be UEs 115, network entities 105, other devices, or any combination thereof. In some examples, the devices may exchange one or more capability messages, control messages, or both to initiate an FMCW-based channel estimation procedure described herein. Such signaling may be described in further detail elsewhere herein, including with reference to FIGS. 3-7.

After the FMCW-based channel estimation procedure is initiated, the transmitting device 205 may generate an FMCW signal 220 (e.g., a first FMCW signal). In some examples, the transmitting device 205 may generate the FMCW signal 220 in an analog domain using a voltage controlled oscillator (VCO) 245. The transmitting device 205 may transmit the FMCW signal 220 via the channel 215 using at least one antenna element at the transmitting device 205. The analog domain FMCW signal 220 generated and transmitted by the transmitting device 205 may be represented by x_{RF,Tx}(t). The radio frequency FMCW signal 225 that is received by the receiving device 210 via the channel 215 in response to the FMCW signal 220 transmitted by the transmitting device 205 may be represented by y_{RF,Rx}(t). The FMCW signal 220 may be a wideband signal. That is, the FMCW signal 220 may occupy a relatively wide frequency range or bandwidth within the channel 215.

As described herein, the receiving device 210 may generate an FMCW signal 230 at the receiving device. The FMCW signal 230 generated at the receiving device 210 may be referred to as a second FMCW signal or a local FMCW signal. The receiving device 210 may generate the FMCW signal 230 in the analog domain using a VCO 255 at the receiving device 210. The receiving device 210 may generate the FMCW signal 230 at the same time as or after receiving the FMCW signal 225. The FMCW signal 230 generated by the receiving device 210 may be represented by x_{RF,Rx}(t). The receiving device 210 may generate the FMCW signal 230 based on a set of FMCW parameters associated with the FMCW signal 220 transmitted by the transmitting device 205. The set of FMCW parameters may include, for example, the starting frequency (f_{c}) of the FMCW signal 220, the slope(S) of the FMCW signal 220, an initial phase of a transmitting device (e.g., φ_{Tx}), or any combination thereof. That is, the FMCW signal 230 generated by the receiving device 210 may have a same starting frequency and slope as the FMCW signal 220 generated by the transmitting device 205.

After generating the FMCW signal 230 configured for channel estimation, the receiving device 210 may generate a combined FMCW signal 235 (e.g., y_{mixed}(t)). To generate the combined FMCW signal 235, the receiving device 210 may combine the FMCW signal 225 received at the receiving device 210 with the locally generated FMCW signal 230 using a mixer 250. The mixer 250 may represent an example of one or more components (e.g., hardware, software, or both) of the receiving device 210 that are configured to combine two or more time-domain FMCW signals. In some examples, the combining may include multiplying the FMCW signals (e.g., y_{mixed}(t)=y_{RF,Rx}(t)x_{RF,Rx}(t)).

The receiving device 210 may filter the combined FMCW signal 235 using an LPF 260 at the receiving device 210. The LPF 260 may generate a combined and filtered FMCW signal 240 (e.g., y_{mixed,LPF}(t)). The LPF 260 may represent an example of a component of the receiving device 210 that is configured to filter signals, or a function supported by the receiving device 210, or both. For example, the receiving device 210 may apply an LPF function to the combined FMCW signal 225 (e.g., y_{mixed,LPF}(t)=LPF[y_{RF,Rx}(t)x_{RF,UE}(t)]). The combined and filtered FMCW signal 240 may be a narrowband signal after the LPF 260. That is, the combined and filtered FMCW signal 240 may occupy a relatively narrow frequency range within a system bandwidth.

After combining and filtering the FMCW signals, the receiving device 210 may perform frequency domain channel estimation using time-domain signal processing based on sampling the combined and filtered FMCW signal 240. The receiving device 210 may use an ADC 265 to sample the combined and filtered FMCW signal 240 in the time domain. A sampling rate used to sample the combined and filtered FMCW signal 240 may be based on one or more parameters associated with the channel 215. For example, the sampling rate may be based on a frequency range of one or more subbands in the channel 215 (e.g., the sampling rate,

$$\frac{1}{{T}_{s}} ,$$

may be equal to an inverse of

$${T}_{s} = \frac{1}{{F}_{s}} = \frac{{f}_{subband}}{S} ) .$$

The subband frequency range, f_{subband}, may represent a granularity at which the receiving device 210 can estimate the channel 215 in the frequency domain.

The sampling by the receiving device 210 as part of the channel estimation may produce a sampling sequence, which may represent a set of values associated with the OFDM channel estimation. The sampling sequence may have a granularity of f_{subband}. For example, each value of the sampling sequence may represent an example of an estimated value of a respective frequency subband of the OFDM channel 215. In one example, if the subband frequency range f_{subband} of the OFDM channel 215 is equal to one resource element, then the sampling sequence may include a respective sample or estimated value of each resource element in the channel 215 (e.g., per comb). In some examples, the subband frequency range f_{subband} may be any other granularity, such as a set of two or more resource elements, a resource block, or some other frequency range.

The receiving device 210 may thereby estimate the frequency domain channel 215 using time domain signal processing and with a granularity of f_{subband} based on the FMCW signal 225 received at the receiving device 210 and the FMCW signal 230 generated by the receiving device 210. The described FMCW-based channel estimation techniques may be performed by the receiving device 210 in the time domain using time domain signal processing. That is, the receiving device 210 may refrain from applying FFT or other frequency transforms when using the FMCW signals to estimate the frequency domain channel 215. By performing the channel estimation in the time domain, the receiving device 210 may reduce processing complexity, latency, and power consumption as compared with other channel estimation techniques performed at least partially in the frequency domain (e.g., using FFT). Additionally, or alternatively, the receiving device 210 may estimate the frequency domain channel 215 using both wideband radio frequency processing and narrowband radio frequency processing. For example, the FMCW signal 225 received at the receiving device 210 may be a wideband signal in the radio frequency, and after the LPF 260, the combined and filtered FMCW signal 240 may be a narrowband signal for baseband processing.

The sampling rate used by the receiving device 210 to estimate the frequency domain channel 215 using FMCW signals may be relatively low as compared with other channel estimation techniques, which may reduce an ADC sampling rate and improve ADC sampling gain. For example, the FMCW-based channel estimation techniques may utilize some relatively small percentage of a sampling rate of an OFDM-based channel estimation technique (e.g., 1.69%, or some other percentage or portion). The FMCW-based channel estimation described herein may reliably estimate the frequency domain channel 215 using the reduced sampling rate. For example, an accuracy of the FMCW-based channel estimation techniques may be relatively similar to an accuracy of other channel estimation techniques, such as OFDM-based channel estimation techniques. That is, the described techniques may maintain or improve accuracy and reliability of estimations of frequency domain channels 215 while reducing processing and power consumption.

FIGS. 3A and 3B show examples of frequency estimation diagrams 300-a and 300-b that support channel granularity for FMCW-based channel estimation in accordance with one or more aspects of the present disclosure. The frequency estimation diagrams 300-a and 300-b may implement or be implemented by aspects of the wireless communications system 100 and the channel estimation scheme 200, as described with reference to FIGS. 1 and 2. For example, the frequency estimation diagrams 300-a and 300-b illustrate examples of how much of a frequency band 305 (e.g., an overall channel bandwidth) a UE 115 may estimate from a narrowband baseband in accordance with different channel estimation techniques. The UE 115 may represent an example of a UE 115 or other receiving device, as described with reference to FIGS. 1 and 2. The channel being estimated may represent a channel between the UE 115 and another transmitting device, such as a network entity 105, as described with reference to FIGS. 1 and 2.

FIG. 3A illustrates a first example frequency estimation diagram 300-a. In this example, the UE 115 may perform an OFDM channel estimation procedure. The UE 115 may support a UE baseband processing ability, which may correspond to a narrowband baseband, as illustrated by the checkered shading in FIG. 3A. The narrowband baseband may represent a relatively narrow range of frequencies that are supported by the UE 115 before modulating or processing the channel. The frequency band 305-a may represent a bandwidth of the channel or system. The frequency band 305-a may be, for example, 100 MHz for a first frequency range (e.g., FR1) and 400 or 800 MHz for a second frequency range (e.g., FR2), or some other frequency range size. Estimating a wideband channel using a narrowband baseband may be relatively cost efficient and associated with relatively low complexity.

The UE 115 may not be able to estimate the whole frequency band 305-a from the narrowband baseband using OFDM channel estimation. Instead, at a given time, the UE 115 may estimate a portion of the frequency band 305-a (e.g., 20 MHz from a 100 MHz band, or some other portion), as illustrated by the checkered shading in the frequency band 305-a illustrated in FIG. 3. The non-shaded portions may represent portions of the frequency band 305-a that the UE 115 may not be able to estimate at the same time.

In some examples, to estimate the entire frequency band 305-a from the narrowband baseband processing ability of the UE 115 using OFDM channel estimation, the UE 115 may perform frequency hopping. For example, the UE 115 may estimate different frequency portions of the frequency band 305-a that are relatively the same size as the narrowband baseband at different times using frequency hopping. In such cases, the UE 115 may be able to estimate the whole frequency band 305-a using the narrowband baseband over time, but such frequency hopping may be relatively complex.

FIG. 3B illustrates a second example frequency estimation diagram 300-b. In this example, the UE 115 may perform an FMCW-based channel estimation procedure. The UE 115 may support the same UE baseband processing ability as illustrated in FIG. 3A, which is shown by the checkered shading in FIGS. 3A and 3B. The baseband processing ability may correspond to a narrowband baseband, as described with reference to FIG. 3A.

The FMCW-based channel estimation procedure may support estimation, by the UE 115, of the whole frequency band 305-b (e.g., the whole channel bandwidth) using the narrowband baseband at a time. That is, a property of the FMCW-based channel estimation may be that the UE 115 is capable of estimating a wideband radio frequency using narrowband baseband processing while maintaining channel characteristics. The whole channel bandwidth may be extracted from the narrowband baseband information.

The FMCW-based channel estimation procedure may include the UE 115 receiving a wideband FMCW signal, generating a local FMCW signal, combining the signals, and filtering the signals to generate a narrowband signal, as described in further detail elsewhere herein, including with reference to FIG. 2. The UE 115 may perform channel estimation based on the narrowband combined and filtered signal. The UE 115 may thereby be capable of estimating the frequency band 305-b using the narrowband signal, because the narrowband signal may include the wideband information. Such FMCW-based channel estimation may reduce costs and processing complexity as compared with other channel estimation techniques, such as OFDM channel estimation techniques.

The FMCW-based channel estimation procedure may be associated with some different types of channel estimation error. In some examples, some channel estimation error may be based on a subband CSI reporting mechanism. For example, the UE 115 may estimate channel parameters per subband of the channel, and the UE 115 may transmit a single CSI report for each subband. However, some subbands may include one or more tones, which may be associated with one or more different channels, such that a single CSI report may not accurately represent the channel. As a subband size increases, the channel estimation error may increase accordingly. Such subband CSI reporting error may occur during other types of channel estimation, including OFDM channel estimation.

Additionally, or alternatively, the FMCW signal may experience one or more delays when conveyed via a channel. A maximum channel delay spread may be associated with a channel estimation error term due to properties of the FMCW. Such channel estimation error may be referred to as FMCW-based channel estimation error. The channel estimation error may increase as the delay spread of the channel increases.

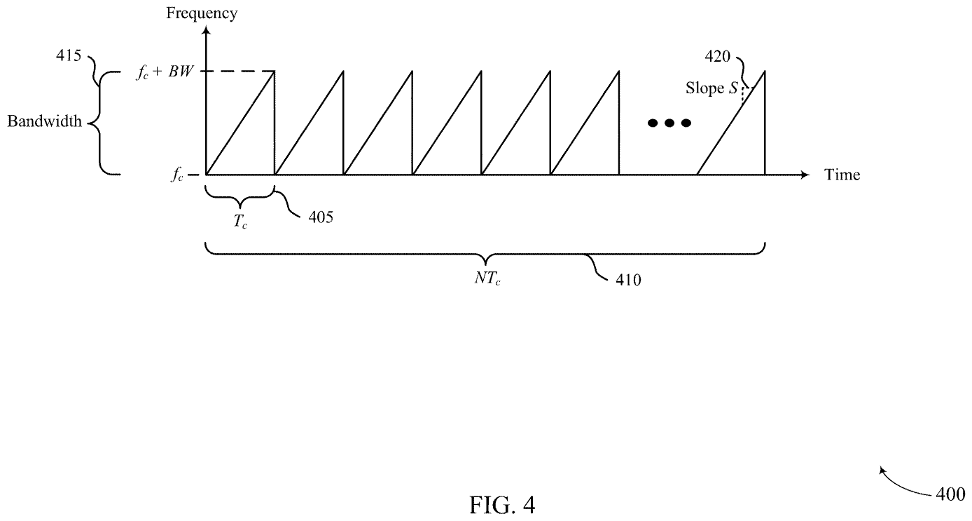

Techniques, systems, and devices described herein provide for a UE 115 to perform FMCW-based channel estimation to achieve a relatively low sampling rate, complexity, and cost, while reducing channel estimation error. As described herein, the UE 115 may perform the FMCW-based channel estimation based on measurements of one or more channel parameters, such as a delay associated with the channel and a Doppler-based frequency shift associated with the channel. The UE 115 and a corresponding network entity 105 may determine a subband granularity for the FMCW-based channel estimation, a type of FMCW-based channel estimation to perform, or both, based on the measured channel parameters, which may improve reliability and efficiency of the FMCW-based channel estimation. Techniques for determining FMCW-based channel estimation parameters based on measurements of the channel are described in further detail elsewhere herein, including with reference to FIGS. 4-8.

FIG. 4 shows an example of an FMCW signal 400 that supports channel granularity for FMCW-based channel estimation in accordance with one or more aspects of the present disclosure. The FMCW signal 400 may implement or be implemented by aspects of the wireless communications system 100 and the channel estimation scheme 200, as described with reference to FIGS. 1 and 2. For example, the FMCW waveform 400 illustrates a waveform that may be generated by a transmitting device using a VCO in the analog domain. In this example, a Doppler-based frequency shift may be applied during transmission and reception of the FMCW signal 400, and may be used to perform channel estimation with improved reliability.

The FMCW signal 400 may include multiple FMCW chirps, each having a chirp duration 405 (Tc). Each chirp may be transmitted via a symbol of a slot within a channel, or some other transmission time interval. A duration 410 of the FMCW signal 400 may be equal to a product of a quantity of chirps included in the FMCW signal 400 and the chirp duration 405 (e.g., NT_{c}, where N represents the quantity of chirps included in the FMCW signal 400). The FMCW signal 400 may be associated with a varying (e.g., increasing) transmit frequency over time according to a slope 420 during each FMCW chirp (e.g., each symbol). Each FMCW chirp may be associated with a same slope 420 (S), which may correspond to a quotient of the bandwidth 415 and the chirp duration 405.

The FMCW signal 400 may be transmitted via a bandwidth 415 (e.g., BW) of a channel in the frequency domain and over time. The bandwidth 415 may include one or more resource blocks in the frequency domain. The FMCW signal 400 may span frequencies between the starting frequency f_{c} and a sum of the starting frequency and the bandwidth 415 (e.g., {f_{c}, f_{c}+BW}). That is, the transmit frequency may vary across the bandwidth 415 of the channel during each FMCW chirp. At the transmitter, each FMCW chirp signal transmitted by the device may be represented by Equation 1.

$${x}_{RF , Tx} ( t ) = cos ( 2 π ( {f}_{c} + \frac{S}{2} t ) t + {ϕ}_{0} ) \qquad ( 1 )$$

As shown in Equation 1, the FMCW signal 400 may be a time-domain signal (e.g., a function of time (t)). In the example of Equation 1, f_{c} may represent a starting frequency of the FMCW signal 400, S may represent a slope 420 of the FMCW signal 400, and φ₀ may represent an initial phase of the FMCW signal 400, which may correspond to a phase of a transmitting device. In some examples, Equation 1 may represent the FMCW signal 220 described with reference to FIG. 2.

A receiving device may receive the FMCW signal 400 including multiple FMCW chirps. The received FMCW signal 400 may represent an example of the FMCW signal 225 described with reference to FIG. 2. The i-th chirp received out of N total chirps in the FMCW signal 400 may be represented by Equation 2.

$${y}_{R F , R x} ( t , i ) = {\sum }_{p = 0}^{P - 1} {A}_{p} cos ( 2 π ( {f}_{c} + {f}_{d , p} + \frac{S}{2} ( t - {τ}_{p} ) ) ( t - {τ}_{p} ) + {ϕ}_{0} ) + n ( t ) \qquad ( 2 )$$

In the example of Equation 2, P may represent a quantity of channel delay paths (e.g., a quantity of multi-paths) associated with the channel, and τₚ may represent a given channel delay with index p. That is, the received FMCW signal 400 may be sampled over various channel delays (e.g., p=0 to P−1). Ap may represent conditions of the channel and n(t) may represent channel noise. In some examples, the channel noise may be associated with a relatively small value relative to the other values that define the radio frequency FMCW signal 400 that is received by the receiving device in Equation 2. In this example, a Doppler-based frequency shift of each path (e.g., the p-th path) of the FMCW signal 400 may be accounted for by f_{d,p}.

As described with reference to FIG. 2, the receiving device (e.g., a UE) may generate a local chirp signal using a VCO at the receiving device (e.g., the local FMCW signal 230 described with reference to FIG. 2). The local chirp signal may be the same for each chirp, and may be represented by Equation 3.

$${x}_{RF , UE} ( t , i ) = exp ( - j ( 2 π ( {f}_{c} + \frac{S}{2} t ) t + {ϕ}_{0} ) ) \qquad ( 3 )$$

The UE may subsequently combine and filter the locally generated signal with the received FMCW signal 400 using one or more components, such as a mixer and a LPF, as described with reference to FIG. 2. The combined and filtered FMCW signal may be represented by Equation 4.

$${y}_{m i x e d , L P F} ( t ) = {\sum }_{p = 0}^{P - 1} \frac{{A}_{p}}{2} exp ( - j ( 2 π ( {f}_{c} + {f}_{d , p} - \frac{S}{2} {τ}_{p} ) {τ}_{p} ) ) exp ( - j 2 π S {τ}_{p} \cdot t ) \qquad ( 4 )$$

As described with reference to FIG. 2, the combined and filtered FMCW signal (e.g., the combined and filtered FMCW signal 240 in FIG. 2) may be a narrowband signal, and the UE 115 may perform channel estimation by sampling the combined and filtered FMCW signal using an ADC, or some other sampling component. In this example, an error term due to the FMCW-based channel estimation scheme may be represented by Equation 5.

$$exp ( j ( 2 π ( \frac{S}{2} {τ}_{p} ) {τ}_{p} ) ) exp ( - j ( 2 π {f}_{d , p} {τ}_{p} ) ) \qquad ( 5 )$$

As shown in Equation 5, the channel estimation error due to FMCW-based channel estimation may be associated with or based on a channel delay τₚ and a measured Doppler effect or Doppler-based frequency shift f_{d,p}. That is, because the Doppler-based frequency shift is accounted for when receiving an FMCW signal 400, as shown in Equation 2, the channel estimation error may also be based on the Doppler-based frequency shift.

The channel estimation error shown in Equation 5 may represent one part of a total channel estimation error that may occur in some examples. Equation 5 may represent potential error that may occur due to FMCW-based channel estimation. That is, the error term shown in Equation 5 may be based on properties of the FMCW signal 400. In some examples, there may be one or more additional factors that lead to error in the channel estimation performed by the UE 115. For example, a subband CSI reporting mechanism may be associated with a second channel estimation error term shown by Equation 6.

$$exp ( - j 2 π {τ}_{p} ( B {W}_{s u b b a n d} - SCS ) ) \qquad ( 6 )$$

The second channel estimation error term may represent channel estimation error that may occur due to a channel granularity associated with the estimation. For example, the UE 115 may estimate the channel according to a subband granularity, such that the UE 115 may transmit a single channel estimation report per subband. However, the size of the subband may vary. In some examples, a subband may include multiple tones each associated with a different channel or channel measurements. A single channel estimation report for such a subband may introduce error. As shown in Equation 6, the channel estimation error due to subband reporting may be based on a measured channel delay τₚ, a bandwidth or size of a subband BW_{subband}, and a subcarrier spacing (SCS) configured for communications.

A theoretical analysis of the two potential channel estimation errors may identify which error may be contributing to the overall channel estimation more than the other (e.g., a dominant error term). For example, by comparing the two different types of channel estimation error, a device may determine which type of error may affect a channel estimation procedure the most. The device, such as a UE 115, may perform the comparison based on measurements of one or more channel parameters, including SCS, subband bandwidth BW_{subband} channel delay τₚ, and Doppler-based frequency shift f_{d,p}, among other parameters. For example, if Equation 7 is true, the dominant channel estimation error may be the subband reporting mechanism, and the error caused by FMCW-based channel estimation may be neglected or ignored.

$${τ}_{p} \cdot ( {BW}_{s u b b a n d} - S C S ) \geq ( \frac{S}{2} {τ}_{p} ) {τ}_{p} - {f}_{d , p} {τ}_{p} \qquad ( 7 )$$

Equation 7 may be expanded to Equation 8.

$${τ}_{p} \leq \frac{2 \cdot ( {N}_{R E}^{SB} - 1 )}{{N}_{R E}^{W B} \cdot SCS} + \frac{4 \cdot {v}_{p} \cdot {f}_{c}}{c \cdot {N}_{R E}^{W B} \cdot SCS \cdot SCS} \qquad ( 8 )$$

In this example,

$${N}_{R E}^{S B}$$

may represent a quantity of resource elements in a subband (e.g., a subband size),

$${N}_{RE}^{S B}$$

may represent a quantity of resource elements in a wideband or channel bandwidth (e.g., the bandwidth 415), f_{c} may represent a starting frequency of the FMCW signal 400, vₚ may represent a propagation velocity associated with the FMCW signal 400, which may impact the Doppler-based frequency shift. If Equations 7 and 8 are true, the signal processing may be relatively low due to the processing saved by performing FMCW-based channel estimation, as described with reference to FIG. 2.

In some other examples, Equation 9 may be true. In such cases, a dominant source of error in the channel estimation may be based on the FMCW signal properties.

$${τ}_{p} \cdot ( {BW}_{s u b b a n d} - S C S ) < ( \frac{s}{2} {τ}_{p} ) {τ}_{p} - {f}_{d , p} {τ}_{p} \qquad ( 9 )$$

Equation 9 may be expanded to Equation 10.

$${τ}_{p} > \frac{2 \cdot ( {N}_{R E}^{SB} - 1 )}{{N}_{R E}^{W B} \cdot SCS} + \frac{4 \cdot {v}_{p} \cdot {f}_{c}}{c \cdot {N}_{R E}^{W B} \cdot SCS \cdot SCS} \qquad ( 10 )$$

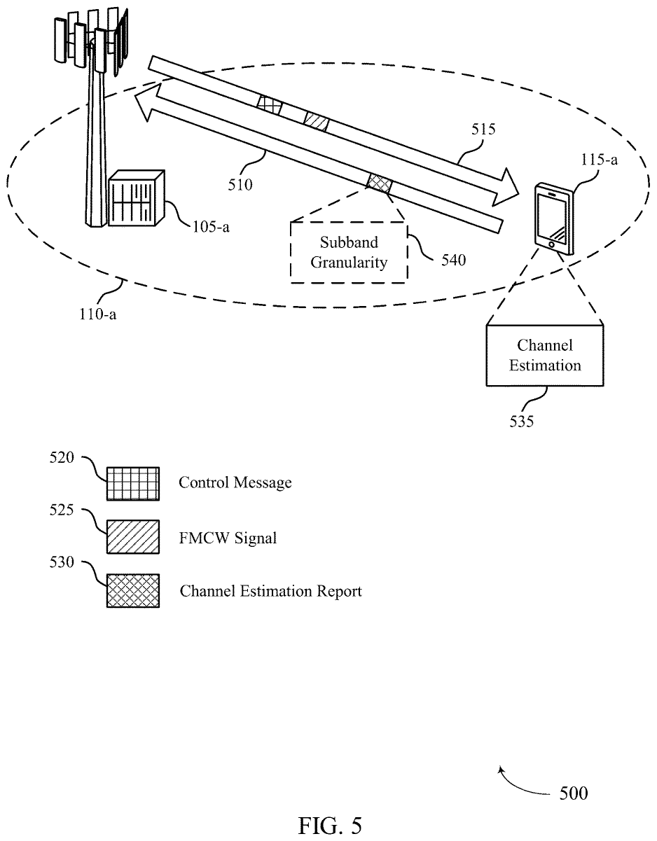

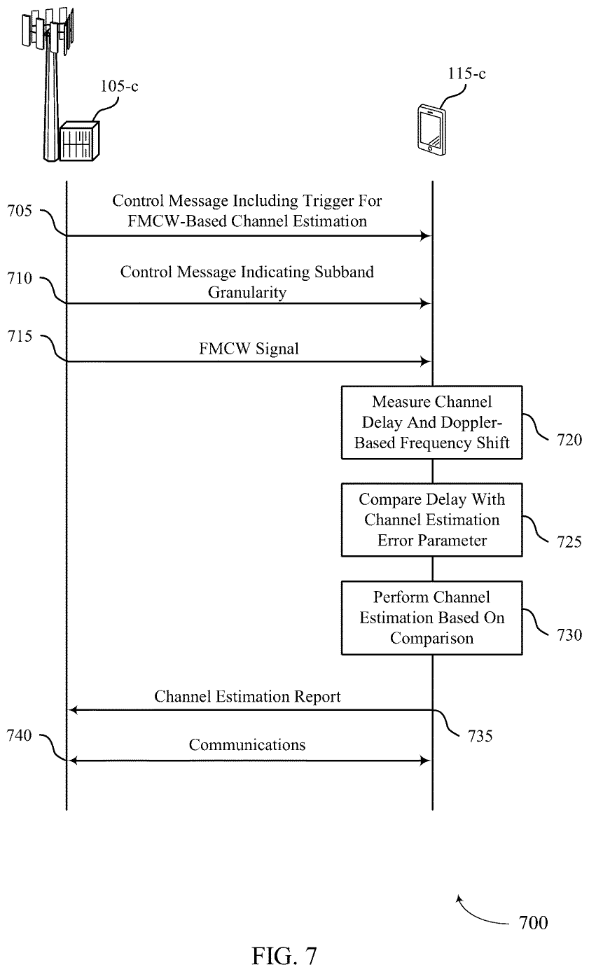

If Equations 9 and 10 are true, then the error caused by FMCW-based channel estimation may have an impact on channel estimation. If such error is ignored, a channel estimation may be associated with relatively high errors. In such cases, a receiving device, such as a UE 115, may perform a per-tap phase compensation-based channel estimation method to compensate the error term due to FMCW properties (e.g., the right side of Equation 9). Per-tap phase compensation is described in further detail elsewhere herein, including with reference to FIGS. 5 and 7.

Techniques, systems, and devices described herein provide for a UE 115 and a network entity 105 to leverage the theoretical analysis of channel estimation error described with reference to Equations 7-10 to improve FMCW-based channel estimation. For example, a UE 115 may estimate a channel as part of an FMCW-based channel estimation procedure according to a subband granularity, where the subband granularity, the channel estimation, or both are based on an FMCW signal, a measured delay associated with the channel, and a measured Doppler-based frequency shift associated with the channel. By utilizing the measurements of channel delay and channel Doppler-based frequency shift to determine how to perform channel estimation, the UE 115 may account for a dominant source of channel estimation error, which may improve reliability and reduce processing complexity.

FIG. 5 shows an example of a wireless communications system 500 that supports channel granularity for FMCW-based channel estimation in accordance with one or more aspects of the present disclosure. The wireless communications system 500 may include a network entity 105-a and a UE 115-a, which may represent examples of a network entity 105 and a UE 115 as described with reference to FIGS. 1-4. The network entity 105-a and the UE 115-a may communicate within a geographic coverage area 110-a and via an uplink communication link 510 and a downlink communication link 515. In some examples, the UE 115-a may perform an FMCW-based channel estimation 535 to estimate a channel between the UE 115-a and the network entity 105-a based on measurements of an FMCW signal 525, as well as measurements of delay and Doppler-based frequency shifts within the channel.

The UE 115-a may support FMCW-based channel estimation 535. In some examples, the UE 115-a may transmit a capability message (not pictured in FIG. 5) to the network entity 105-a to indicate the capability of the UE 115-a to support FMCW-based channel estimation 535. The network entity 105-a may transmit a control message 520 via the downlink communication link 515 to the UE 115-a. The control message 520 may include a trigger or request for the UE 115-a to perform an FMCW-based channel estimation procedure 535 and transmit an associated channel estimation report 530. The network entity 105-a may subsequently transmit an FMCW signal 525 to the UE 115-a via the downlink communication link 515. The FMCW signal 525 may represent an example of the FMCW signal 400 described with reference to FIG. 4 and may be transmitted in accordance with the control message 520 and one or more FMCW parameters.

The UE 115-a may receive the FMCW signal 525 and perform channel estimation 535 based on the FMCW signal 525. In some examples, performing the channel estimation 535 may include processing the full channel bandwidth from a narrowband signal using time domain signal processing, which may be associated with relatively low processing complexity and improved estimation reliability, as described with reference to FIGS. 2 and 3. The FMCW-based channel estimation 535 may be based on or performed in accordance with a subband granularity 540, which may represent a size of a subband (e.g., a quantity of resource elements in each subband of the channel), a quantity of subbands in the channel, or both. For example, the UE 115-a may estimate and report one or more channel parameters for each subband. As described with reference to FIG. 4, some channel estimation error may occur due to the subband granularity.

In some examples described herein, the UE 115-a may select the subband granularity 540 for performing the channel estimation 535 based on one or more channel measurements and one or more functions to reduce channel estimation error. Additionally, or alternatively, the network entity 105-a may select the subband granularity. In either case, the UE 115-a may perform the channel estimation 535 based on measurements of channel metrics, including a measured channel delay and a measured Doppler-based frequency shift associated with the channel. By performing the channel estimation 535 using the delay and Doppler-based frequency shift, the UE 115-a may account for and mitigate or reduce potential sources of channel estimation error, which may improve throughput and reliability of the channel estimation 535.

In some examples described herein, the network entity 105-a may instruct or request the UE 115-a to select the subband granularity 540 and report the subband granularity with the associated channel estimation results. The network entity 105-a may include the request in the control message 520 requesting the UE 115-a to perform FMCW-based channel estimation, in a second control message 520, or in some other signaling to the UE 115-a. In this example, the UE 115-a may measure a delay associated with the channel (e.g., a maximum delay spread) and a Doppler-based frequency shift associated with the channel between the UE 115-a and the network entity 105-a. The UE 115-a may select the subband granularity from a set of candidate subband granularities that is based on the measurements.

The set of candidate subband granularities may be calculated or determined by the UE 115-a based on a threshold subband granularity. The threshold subband granularity may be calculated by the UE 115-a based on whether the subband granularity corresponds to a subband size

$$( {N}_{R E}^{S B} )$$

or a quantity of subbands in the channel (N₃). The relationship between the subband size and the quantity of subbands may be

$${N}_{3} = ⌈ \frac{{N}_{RB}^{WB}}{{N}_{RE}^{SB}} ⌉ ,$$

where

$${N}_{R E}^{W B}$$

may represent a size of the channel (e.g., a quantity of resource elements in the wideband channel being estimated). If the subband granularity corresponds to a subband size or quantity of resource elements in each subband of the channel, the set of candidate subband granularities may be calculated according to Equation 11, such that the set of subband granularities may include subband sizes that are greater than or equal to a threshold subband size.

$$min \{ {N}_{R E}^{SB} \} \geq ( max \{ {τ}_{p} \} - \frac{4 \cdot {v}_{p} \cdot {f}_{c}}{c \cdot {N}_{R E}^{W B} \cdot SCS \cdot SCS} ) \cdot \frac{{N}_{R E}^{W B} \cdot SCS}{2} + 1 \qquad ( 11 )$$

As shown in Equation 11, a minimum subband size in the set of candidate subband sizes may be greater than or equal to a threshold subband size. The threshold subband size may be calculated based on a measured channel delay τₚ, and a measured Doppler-based frequency shift f_{d,p}, which may be based at least in part on a propagation velocity vₚ and one or more other parameters, as described with reference to Equations 8 and 10.

If the subband granularity corresponds to a quantity of subbands in the channel, the set of candidate subband granularities may be calculated according to Equation 12, such that the set of subband granularities may include subband quantities that are less than a threshold subband quantity.

$$max \{ {N}_{3} \} \leq ⌈ \frac{{N}_{R E}^{W B}}{( max \{ {τ}_{p} \} - \frac{4 \cdot {v}_{p} \cdot {f}_{c}}{c \cdot {N}_{R E}^{W B} \cdot SCS \cdot SCS} ) \cdot \frac{{N}_{R E}^{W B} \cdot SCS}{2} + 1} ⌉ \qquad ( 12 )$$

As shown in Equation 12, a maximum quantity of subbands in the set of candidate subband quantities may be less than a threshold subband quantity. The threshold subband quantity may be calculated based on a measured channel delay τₚ, and a measured Doppler-based frequency shift f_{d,p}, which may be based at least in part on a propagation velocity vₚ and one or more other parameters, as described with reference to Equations 8 and 10.

By calculating the set of candidate subband granularities (e.g., subband sizes or quantities of subbands per channel) based on the measured delay and Doppler-based frequency shift, the UE 115-a may account for and mitigate or reduce potential channel estimation error. For example, each subband granularity in the set of candidate subband granularities may be determined such that Equations 7 and 8 may be true and a primary or dominant source of channel estimation error may be from a subband reporting mechanism, which may be relatively low. The UE 115-a may select a subband granularity from the candidate set randomly or based on one or more parameters. The UE 115-a may transmit the channel estimation report 530 that reports the results of the channel estimation 535 according to a subband size that is no less than

$$min \{ {N}_{R E}^{S B} \}$$

or a quantity of subbands that is no greater than max {N₃}. The UE 115-a may indicate the selected subband granularity 540 via the channel estimation report 530.

In some examples, the network entity 105-a may indicate the candidate set of subband granularities to the UE 115-a via a control message 520 or some other signaling. The network entity 105-a may indicate a finite candidate set for the subband size

$${N}_{R E}^{S B}$$

or the subband quantities N₃, and the network entity 105-a may indicate that the UE 115-a is to select a subband granularity from the finite candidate set for the channel estimation report. In some examples, the finite candidate set may be defined or configured at the UE 115-a (e.g., preconfigured or defined in a standard). Additionally, or alternatively, the network entity 105-a may indicate the finite candidate set via RRC signaling, via a medium access control-control element (MAC-CE), or via some other type of signaling. The network entity 105-a may configure the finite candidate set dynamically or semi-persistently. In some examples, multiple different candidate sets of subband granularities may be defined or preconfigured, and the network entity 105-a may activate one of the multiple finite candidate sets via signaling to the UE 115-a. For example, the network entity 105-a may transmit signaling (e.g., layer 1 or layer 2 signaling, such as a MAC-CE or downlink control information (DCI)) that indicates an index of or points to one of the candidate sets from among the multiple defined candidate sets. The candidate set(s) may be defined based on Equations 11 and 12, in some examples, to reduce channel estimation error. The UE 115-a may select a subband granularity from the indicated candidate set based on, for example, the measured delay and Doppler-based frequency shift associated with the channel, or one or more other parameters or metrics.

The UE 115-a may perform the channel estimation 535 based on the FMCW signal 525 and the selected subband granularity 540. The UE 115-a may transmit, via the uplink communication link 510, a channel estimation report 530 that indicates results of the channel estimation 535 and the associated subband granularity 540. The network entity 105-a may thereby interpret the channel parameters indicated via the channel estimation report 530 as being associated with or determined in accordance with the subband granularity 540.

In some other examples described herein, the network entity 105-a may indicate a subband granularity 540 (e.g., a subband size or a quantity of subbands) to the UE 115-a. The network entity 105-a may transmit the indication of the subband granularity 540 via the control message 520 that requests the UE 115-a to perform FCMW-based channel estimation 535 or via a second message, or both. The network entity 105-a may select the subband granularity 540 autonomously based on one or more protocols or communication parameters and may indicate the selected subband granularity (e.g., a value of

$${N}_{R E}^{SB}$$

or N₃) to the UE 113-a explicitly.

Additionally, or alternatively, the UE 115-a may transmit, via a previous channel estimation report 530 or some other uplink message (e.g., a MAC-CE, uplink control information (UCI), or some other uplink signaling), an indication of a subband granularity 540 selected by the UE 115-a, and the subband granularity 540 indicated by the network entity 105-a may be an adjustment from the previously indicated subband granularity 540. The network entity 105-a may adjust a previously indicated subband granularity 540 to a different subband granularity 540 based on one or more channel metrics, such as a block error rate (BLER), or other performance metrics associated with communications between the UE 115-a and the network entity 105-a.

The network entity 105-a may thereby select a subband granularity 540 based on one or more channel metrics and indicate the selected subband granularity 540 to the UE 115-a when requesting the UE 115-a to perform a channel estimation 535. If the UE 115-a receives an indicated subband granularity 540, the UE 115-a may determine how to perform the channel estimation 535 based on the subband granularity 540, a measured delay associated with the channel, and a measured Doppler-based frequency shift associated with the channel. For example, the UE 115-a may calculate a channel estimation parameter based at least in part on the Doppler-based frequency shift, and the UE 115-a may compare the channel delay with the channel estimation error parameter. Such comparison may indicate a primary source of error in the channel estimation 535. The UE 115-a may determine whether to perform the channel estimation 535 using a per-tap phase compensation method based on the comparison, as described in further detail elsewhere herein, including with reference to FIG. 7. The UE 115-a may thereby perform the channel estimation 535 according to the indicated subband granularity 540 and based on one or more measured channel parameters to reduce latency and improve reliability of the channel estimation 535.

The UE 115-a may estimate the channel in accordance with the subband granularity 540, regardless of whether the subband granularity 540 is indicated by the network entity 105-a or determined by the UE 115. The channel estimation 535 may thereby be based on the measured delay and Doppler-based frequency shift. After estimating the channel, the UE 115-a may transmit a channel estimation report 530 (e.g., a CSI report, or some other type of report) that indicates one or more channel parameters based on the estimation. In some examples, the channel estimation report 530 may include a respective set of measured or estimated channel parameters for each subband in accordance with the subband granularity. Additionally, or alternatively, the channel estimation report 530 may include a respective set of measured or estimated channel parameters for each tap of multiple taps or different channel delays of the FMCW signal 525. The channel parameters may include, for example, a subband channel quality indicator (CQI), a subband precoding matrix indicator (PMI), a received signal strength indicator (RSSI), one or more other subband channel parameters, or any combination thereof.

The UE 115-a and the network entity 105-a may perform subsequent communications via the uplink communication link 510 and the downlink communication link 515 based on the channel parameters indicated via the channel estimation report 530 and the subband granularity. By accounting for potential errors in the channel estimation 535, the UE 115-a may mitigate or reduce channel estimation error, which may reduce processing, reduce latency, and improve throughput and reliability of communications.

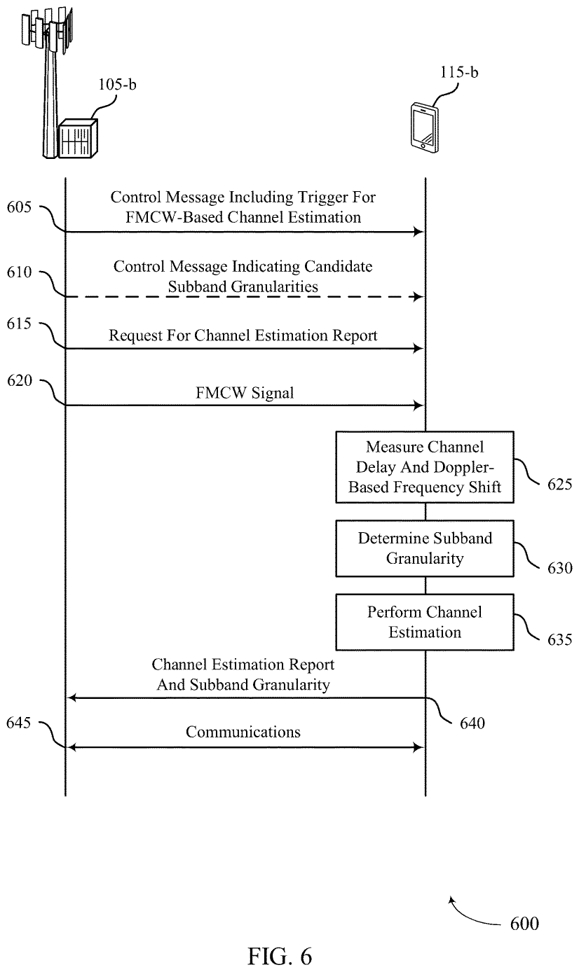

FIG. 6 shows an example of a process flow 600 that supports channel granularity for FMCW-based channel estimation in accordance with one or more aspects of the present disclosure. The process flow 600 may implement or be implemented by aspects of FIGS. 1-5. For example, the process flow 600 illustrates communications between a network entity 105-b and a UE 115-b, which may represent aspects of corresponding devices as described with reference to FIGS. 1-5. In some aspects, the UE 115-b may select a subband granularity for performing an FMCW-based channel estimation based on a measured channel delay, Doppler-based frequency shift, or both.

In the following description of the process flow 600, the operations between the network entity 105-b and the UE 115-b may be performed in different orders or at different times. Some operations may also be left out of the process flow 600, or other operations may be added. Although the network entity 105-b and the UE 115-b are shown performing the operations of the process flow 600, some aspects of some operations may also be performed by one or more other wireless devices.

At 605, the network entity 105-b may transmit a control message including a request or trigger for the UE 115-b to perform an FMCW-based channel estimation. The control message may include one or more parameters for the FMCW-based channel estimation. At 610, in some examples, the network entity 105-b may transmit a second control message to the UE 115-b to indicate a set of candidate subband granularities for the UE 115-b to select from. The second control message may be an RRC message, a MAC-CE, DCI, or some other type of signaling that may define the candidate set or may indicate the candidate set from among multiple defined candidate sets, as described with reference to FIG. 5.

At 615, the network entity 105-b may transmit a third control message to the UE 115-b to request the UE 115-b to generate and transmit a channel estimation report based on the FMCW-based channel estimation. The third control message may include a request for the UE 115-b to select and report a subband granularity for the FMCW-based channel estimation. Although separate control messages are illustrated in FIG. 6, it is to be understood that, in some examples, one or more of the request to perform FMCW-based communications, the indication of the set of candidate subband granularities, and the request for the channel estimation report may be transmitted in a same control message.

At 620, the network entity 105-b may transmit an FMCW signal to the UE 115-b via a channel between the network entity 105-b and the UE 115-b. The FMCW signal may be transmitted in accordance with one or more FMCW parameters and may be based on any one of the previously transmitted control messages.

At 625 the UE 115-b may measure a delay (e.g., a maximum delay spread) associated with the channel and a Doppler-based frequency shift associated with the channel. The UE 115-b may measure the delay, the Doppler-based frequency shift, and one or more other channel parameters or metrics based on the received FMCW signal and the requests from the network entity 105-b.

At 630, the UE 115-b may determine or select a subband granularity for the FMCW-based channel estimation. The UE 115-b may determine a set of candidate subband granularities that includes the subband granularity based on the indication received from the network entity 105-b, based on the measured delay and Doppler-based frequency shift associated with the channel, or both. To determine the set of candidate subband granularities, the UE 115-b may calculate a threshold subband size or a threshold quantity of subbands based on a function of the measured delay and the measured Doppler-based frequency shift, as described with reference to Equations 11 and 12. The set of candidate subband sizes may include subband sizes that are greater than or equal to a respective threshold, and the set of candidate subband quantities may include quantities of subbands that are less than a respective threshold. The UE 115-b may select a subband granularity from the candidate set based on one or more parameters or metrics. The selected subband granularity may thereby account for and reduce potential sources of channel estimation error.

At 635, the UE 115-b may perform the FMCW-based channel estimation. The UE 115-b may estimate the channel between the UE 115-b and the network entity 105-b in accordance with the selected subband granularity (e.g., based on the measured delay and Doppler-based frequency shift). The UE 115-b may estimate one or more channel parameters according to the subband granularity. For example, the UE 115-b may estimate one or more of a subband channel CQI, a subband PMI, an RSSI, one or more other subband channel parameters, or any combination thereof.

At 640, the UE 115-b may transmit a channel estimation report, which may be a CSI report in some examples, to the network entity 105-b. The UE 115-b may transmit, via the channel estimation report, an indication of the subband granularity selected at 630. One or more bits or fields in the channel estimation report may be configured to convey the subband granularity. The channel estimation report may additionally indicate the channel parameters estimated by the UE 115-b in accordance with the subband granularity.

At 645, the UE 115-b and the network entity 105-b may communicate in accordance with the subband granularity and based on the channel parameters indicated via the channel estimation report. The UE 115-b may thereby select a subband granularity and perform channel estimation based on measurements of a delay and Doppler-based frequency shift associated with the channel. By accounting for delay and Doppler shifts when selecting the subband granularity, the UE 115-b may select a subband granularity that may produce less than a threshold amount of subband channel estimation error, which may improve reliability and reduce complexity associated with the channel estimation.

FIG. 7 shows an example of a process flow 700 that supports channel granularity for FMCW-based channel estimation in accordance with one or more aspects of the present disclosure. The process flow 700 may implement or be implemented by aspects of FIGS. 1-6. For example, the process flow 700 illustrates communications between a network entity 105-c and a UE 115-c, which may represent aspects of corresponding devices as described with reference to FIGS. 1-6. In some aspects, the UE 115-c may account for a measured channel delay, Doppler-based frequency shift, or both when performing an FMCW-based channel estimation in accordance with a subband granularity selected by the network entity 105-c.

In the following description of the process flow 700, the operations between the network entity 105-c and the UE 115-c may be performed in different orders or at different times. Some operations may also be left out of the process flow 700, or other operations may be added. Although the network entity 105-c and the UE 115-c are shown performing the operations of the process flow 700, some aspects of some operations may also be performed by one or more other wireless devices.

At 705, the network entity 105-c may transmit a control message including a request or trigger for the UE 115-c to perform an FMCW-based channel estimation. The control message may include one or more parameters for the FMCW-based channel estimation. At 710, the network entity 105-c may transmit a second control message to the UE 115-c to indicate or configure a subband granularity for the channel estimation (e.g., a subband size or a quantity of subbands). The second control message may be an RRC message, a MAC-CE, DCI, or some other type of signaling. In some examples, the network entity 105-c may transmit the trigger for FMCW-based channel estimation and the indication of the subband granularity via a same control message.

In some examples, the subband granularity indicated by the network entity 105-c may be based on a subband granularity previously selected by the UE 115-c. For example, the UE 115-c may previously select and transmit an indication of a subband granularity to the network entity 105-c as described with reference to FIG. 6, and the network entity 105-c may adjust or change the subband granularity. In such cases, the subband granularity indicated at 710 may be an adjusted subband granularity.

At 715, the network entity 105-c may transmit an FMCW signal to the UE 115-c via a channel between the network entity 105-c and the UE 115-c. The FMCW signal may be transmitted in accordance with one or more FMCW parameters and may be based on the trigger and/or the subband granularity.

At 720 the UE 115-c may measure or estimate a delay (e.g., a maximum delay spread) associated with the channel and a Doppler-based frequency shift associated with the channel. The UE 115-c may measure the delay, the Doppler-based frequency shift, and one or more other channel parameters or metrics based on the received FMCW signal and the trigger and indicated subband granularity from the network entity 105-c.

At 725, the UE 115-c may compare the measured channel delay with a channel estimation error parameter. The UE 115-c may calculate or determine the channel estimation error parameter based on the measured delay and Doppler-based frequency shift. For example, the channel estimation error parameter may be defined by Equation 13, in some examples.

$$\frac{2 \cdot ( {N}_{R E}^{SB} - 1 )}{{N}_{R E}^{W B} \cdot SCS} + \frac{4 \cdot {v}_{p} \cdot {f}_{c}}{c \cdot {N}_{R E}^{W B} \cdot SCS \cdot SCS} \qquad ( 13 )$$

As shown in Equation 13, the channel estimation error parameter may represent a metric or threshold value that is based on multiple channel parameters, including the Doppler-based frequency shift (e.g., based on the propagation velocity vₚ) and the subband granularity (e.g.,

$${N}_{R E}^{S B} ) .$$

As part of the comparison, the UE 115-c may determine whether the measured channel delay τₚ is greater than, equal to, or less than the value of the channel estimation error parameter.

At 730, the UE 115-c may perform channel estimation based on the comparison. For example, the comparison between the channel delay and the channel estimation error parameter may indicate a dominant source of error in the channel estimation, and the UE 115-c may determine a type of channel estimation to perform in order to account for and reduce or mitigate the channel estimation error. If the measured channel delay is less than or equal to the channel estimation error parameter (e.g., τₚ≤Equation 13), the UE 115-c may estimate that a primary source of error may be due to the subband channel reporting granularity, which may be relatively small, and the UE 115-c may thereby perform the channel estimation in accordance with the subband granularity indicated by the network entity 105-c and a sampling rate. For example, the UE 115-c may sample the FMCW signal (e.g., y_{mixed,LPF}(t), as described with reference to FIGS. 2 and 4) at a sample rate of F, where

$${F}_{s} = \frac{1}{{T}_{s}} = \frac{S}{B {W}_{s u b b a n d}} ,$$

to obtain a frequency domain channel.

If the measured channel delay is greater than the channel estimation error parameter (e.g., τₚ>Equation 13), the UE 115-c may estimate that a primary source of error may be due to properties of the FMCW signal, which may have a relatively negative effect on the channel estimation. Accordingly, if the measured channel delay is greater than the channel estimation error parameter, the UE 115-c may perform a per-tap phase compensation type of channel estimation. The per-tap phase compensation may include the UE 115-c estimating the channel, on a per-tap basis. The FMCW signal received by the UE 115-c may be associated with or may include multiple taps and each tap may correspond to a unique channel delay of the FMCW signal. For example, the FMCW signal may take multiple different transmission paths, and each transmission path may correspond to a respective delay and may thereby correspond to a respective tap. By estimating the channel on the per-tap basis, the UE 115-c may account for such variations in channel delay (e.g., a relatively large delay spread), which may improve reliability and accuracy of the channel estimation.

At 735, the UE 115-c may transmit a channel estimation report, which may be a CSI report in some examples, to the network entity 105-c. The channel estimation report may be associated with the subband granularity indicated by the network entity 105-c and based on the channel estimation. The channel estimation report may indicate the channel parameters estimated by the UE 115-c in accordance with the subband granularity. If the UE 115-c performs per-tap phase compensation, the channel estimation report may include channel parameter for each tap of multiple taps of the FMCW signal. If the UE 115-c estimates the channel according to a sampling frequency, the channel estimation report may include channel parameters per subband of the channel.

At 740, the UE 115-c and the network entity 105-c may communicate in accordance with the subband granularity and based on the channel parameters indicated via the channel estimation report. As described herein, if the network entity 105-c selects a subband granularity for FMCW-based channel estimation, the UE 115-c may account for various potential sources of channel estimation error by performing the channel estimation based on measurements of delay and Doppler-based frequency shift associated with the channel, which may improve reliability and accuracy of the channel estimation.

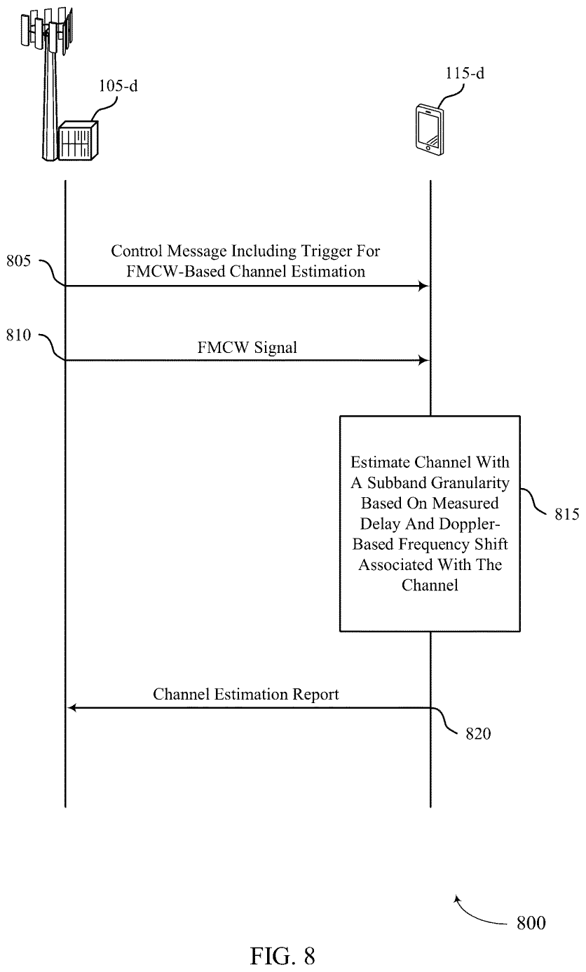

FIG. 8 shows an example of a process flow 800 that supports channel granularity for FMCW-based channel estimation in accordance with one or more aspects of the present disclosure. The process flow 800 may implement or be implemented by aspects of FIGS. 1-7. For example, the process flow 800 illustrates communications between a network entity 105-d and a UE 115-d, which may represent aspects of corresponding devices as described with reference to FIGS. 1-7. In some aspects, the network entity 105-d, the UE 115-d, or both may account for a measured channel delay, Doppler-based frequency shift, or both when performing an FMCW-based channel estimation in accordance with a subband granularity.

In the following description of the process flow 800, the operations between the network entity 105-d, the UE 115-d may be performed in different orders or at different times. Some operations may also be left out of the process flow 800, or other operations may be added. Although the network entity 105-d, the UE 115-d are shown performing the operations of the process flow 800, some aspects of some operations may also be performed by one or more other wireless devices.

At 805, the network entity 105-d may transmit a control message to the UE 115-d. The control message may include a trigger for an FMCW-based channel estimation procedure by the UE 115-d. In some examples, the control message may be based on a capability of the UE 115-d to support FMCW-based channel estimation.

At 810, the network entity 105-d may transmit an FMCW signal to the UE 115-d. The FMCW signal may be transmitted via a channel between the network entity 105-d and the UE 115-d, such as an OFDM channel, or some other type of channel. The FMCW signal may be transmitted based on the trigger indicated via the control message at 805. The FMCW may be associated with one or more FMCW characteristics or properties, such as a slope, a starting frequency, a chirp duration, and a bandwidth, among other parameters as described with reference to FIGS. 2 and 4.

At 815, the UE 115-d may estimate the channel as part of the FMCW-based channel estimation procedure. The UE 115-d may estimate the channel in accordance with a subband granularity (e.g., a subband size or quantity of subbands). The channel estimation may be based on the FMCW signal, a measured delay associated with the channel, and a measured Doppler-based frequency shift associated with the channel. For example, the UE 115-d may receive and measure the FMCW signal and may additionally measure one or more channel parameters, including the delay and the Doppler-based frequency shift. In some examples, the UE 115-d may determine the subband granularity for the channel estimation based on the measured delay and Doppler-based frequency shift, as described with reference to FIGS. 5 and 6. In some other examples, the network entity 105-d may select the subband granularity and may indicate the subband granularity to the UE 115-d before the channel estimation. In such cases, the UE 115-d may determine a type of channel estimation procedure to perform based on the measured delay, the measured Doppler-based frequency shift, and the subband granularity, as described with reference to FIGS. 5 and 7. For example, the UE 115-d may determine whether to perform a per-tap phase compensation-based channel estimation procedure based on the measurements.

At 820, the UE 115-d may transmit a channel estimation report to the network entity 105-d. The UE 115-d may generate and transmit the channel estimation report, which may be referred to as a CSI report in some examples, based on the estimation of the channel at 815. The channel estimation report may include a set of one or more channel parameters and may be associated with the subband granularity. For example, the channel estimation report may indicate respective parameters for each subband of the channel in accordance with the subband granularity. If the UE 115-d selected the subband granularity, the channel estimation report may indicate the selected subband granularity. If the network entity 105-d selected the subband granularity, the channel estimation report may or may not indicate the subband granularity.

The UE 115-d may thereby perform channel estimation based on a received FMCW signal and one or more measured channel parameters. By accounting for the measured channel parameters, such as the measured channel delay and the measured Doppler-based frequency shift, the UE 115-d may select a subband granularity or determine a type of channel estimation to perform in order to account for and reduce potential channel estimation errors, which may improve throughput and reliability of the wireless communications.

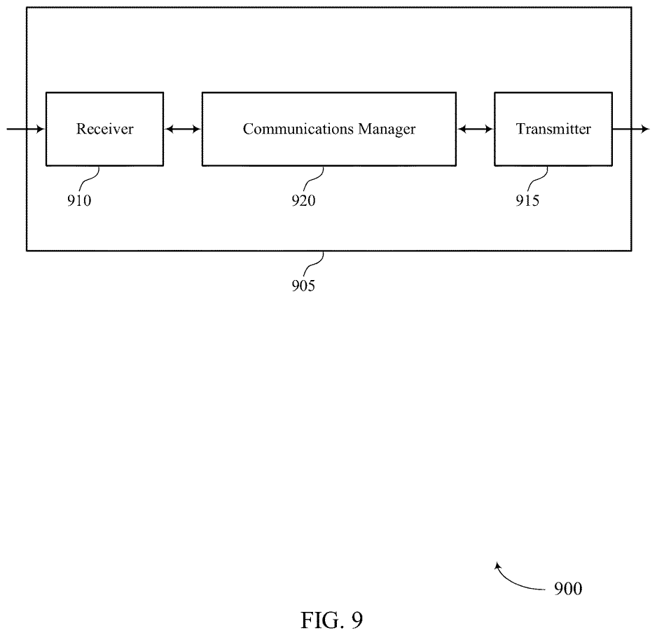

FIG. 9 shows a block diagram 900 of a device 905 that supports channel granularity for FMCW-based channel estimation in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to channel granularity for FMCW-based channel estimation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to channel granularity for FMCW-based channel estimation). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of channel granularity for FMCW-based channel estimation as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

Additionally, or alternatively, the communications manager 920 may support wireless communication at a UE in accordance with examples as disclosed herein. For example, the communications manager 920 is capable of, configured to, or operable to support a means for receiving a control message including a trigger for an FMCW-based channel estimation procedure. The communications manager 920 is capable of, configured to, or operable to support a means for receiving, via a channel, an FMCW signal. The communications manager 920 is capable of, configured to, or operable to support a means for estimating the channel, responsive to the trigger, with a subband granularity as part of the FMCW-based channel estimation procedure, estimation of the channel based on the FMCW signal, a measured delay associated with the channel, and a measured Doppler-based frequency shift associated with the channel. The communications manager 920 is capable of, configured to, or operable to support a means for transmitting a channel estimation report including a set of one or more channel parameters determined via the estimation of the channel, the channel estimation report associated with the subband granularity.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, and more efficient utilization of communication resources.

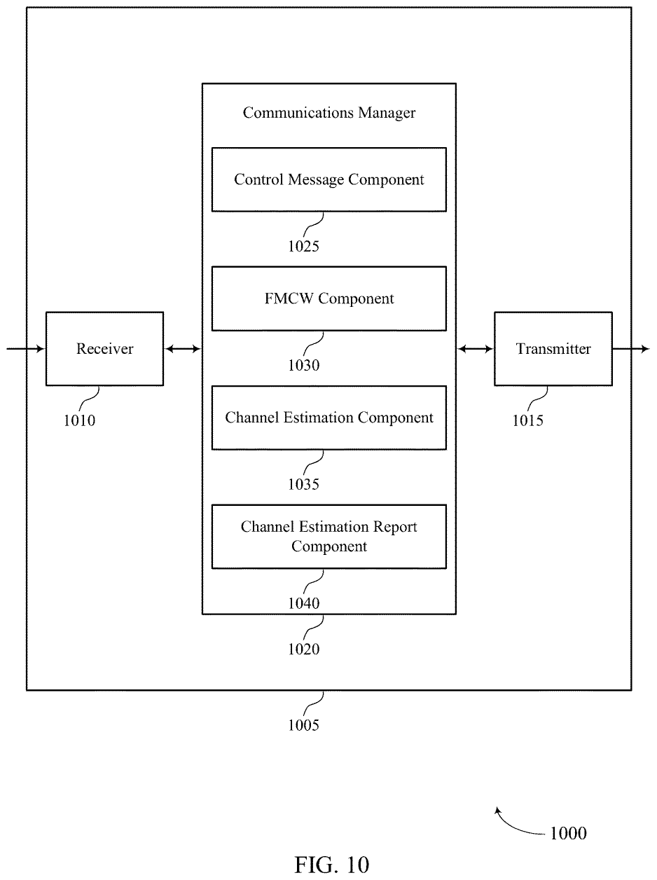

FIG. 10 shows a block diagram 1000 of a device 1005 that supports channel granularity for FMCW-based channel estimation in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to channel granularity for FMCW-based channel estimation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to channel granularity for FMCW-based channel estimation). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of channel granularity for FMCW-based channel estimation as described herein. For example, the communications manager 1020 may include a control message component 1025, an FMCW component 1030, a channel estimation component 1035, a channel estimation report component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE in accordance with examples as disclosed herein. The control message component 1025 is capable of, configured to, or operable to support a means for receiving a control message including a trigger for an FMCW-based channel estimation procedure. The FMCW component 1030 is capable of, configured to, or operable to support a means for receiving, via a channel, an FMCW signal. The channel estimation component 1035 is capable of, configured to, or operable to support a means for estimating the channel, responsive to the trigger, with a subband granularity as part of the FMCW-based channel estimation procedure, estimation of the channel based on the FMCW signal, a measured delay associated with the channel, and a measured Doppler-based frequency shift associated with the channel. The channel estimation report component 1040 is capable of, configured to, or operable to support a means for transmitting a channel estimation report including a set of one or more channel parameters determined via the estimation of the channel, the channel estimation report associated with the subband granularity.

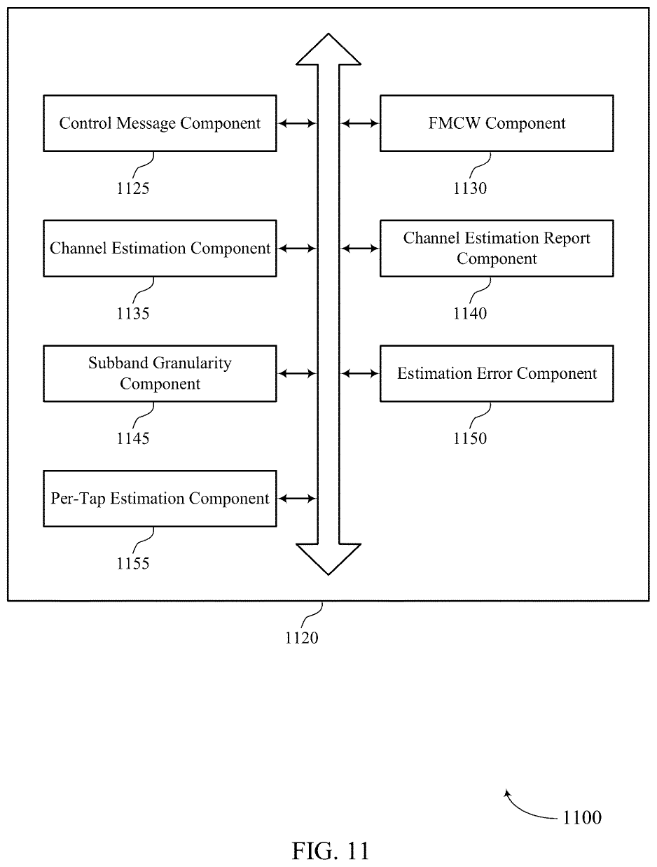

FIG. 11 shows a block diagram 1100 of a communications manager 1120 that supports channel granularity for FMCW-based channel estimation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of channel granularity for FMCW-based channel estimation as described herein. For example, the communications manager 1120 may include a control message component 1125, an FMCW component 1130, a channel estimation component 1135, a channel estimation report component 1140, a subband granularity component 1145, an estimation error component 1150, a per-tap estimation component 1155, or any combination thereof. Each of these components may communicate, directly or indirectly, with one another (e.g., via one or more buses).

Additionally, or alternatively, the communications manager 1120 may support wireless communication at a UE in accordance with examples as disclosed herein. The control message component 1125 is capable of, configured to, or operable to support a means for receiving a control message including a trigger for an FMCW-based channel estimation procedure. The FMCW component 1130 is capable of, configured to, or operable to support a means for receiving, via a channel, an FMCW signal. The channel estimation component 1135 is capable of, configured to, or operable to support a means for estimating the channel, responsive to the trigger, with a subband granularity as part of the FMCW-based channel estimation procedure, estimation of the channel based on the FMCW signal, a measured delay associated with the channel, and a measured Doppler-based frequency shift associated with the channel. The channel estimation report component 1140 is capable of, configured to, or operable to support a means for transmitting a channel estimation report including a set of one or more channel parameters determined via the estimation of the channel, the channel estimation report associated with the subband granularity.

In some examples, the subband granularity component 1145 is capable of, configured to, or operable to support a means for transmitting, via the channel estimation report, an indication of the subband granularity, where the subband granularity is selected from among a set of candidate subband granularities, and where the set of candidate subband granularities is based on the measured delay and the measured Doppler-based frequency shift.

In some examples, the subband granularity component 1145 is capable of, configured to, or operable to support a means for calculating a threshold subband size based on a function of the measured delay and the measured Doppler-based frequency shift, where the subband granularity corresponds to a frequency subband size associated with the channel estimation report, and where the set of candidate subband granularities includes frequency subband sizes that are greater than or equal to the threshold subband size.

In some examples, the subband granularity component 1145 is capable of, configured to, or operable to support a means for calculating a threshold quantity of subbands based on a function of the measured delay and the measured Doppler-based frequency shift, where the subband granularity corresponds to a quantity of frequency subbands associated with the channel estimation report, and where the set of candidate subband granularities includes quantities of frequency subbands that are less than or equal to the threshold quantity.

In some examples, the subband granularity component 1145 is capable of, configured to, or operable to support a means for receiving a control message that indicates the set of candidate subband granularities.

In some examples, the subband granularity component 1145 is capable of, configured to, or operable to support a means for receiving a control message that indicates the set of candidate subband granularities from among a set of multiple defined sets of subband granularities.

In some examples, the control message component 1125 is capable of, configured to, or operable to support a means for receiving a control message that indicates the subband granularity for the FMCW-based channel estimation procedure by the UE. In some examples, the estimation error component 1150 is capable of, configured to, or operable to support a means for comparing, based on the control message, the measured delay associated with the channel with a channel estimation error parameter, where a value of the channel estimation error parameter is based on the subband granularity and the measured Doppler-based frequency shift associated with the channel, and where estimating the channel is based on the comparing.

In some examples, to support estimating the channel, the channel estimation component 1135 is capable of, configured to, or operable to support a means for estimating the channel in accordance with a sampling rate based on the measured delay being less than or equal to the value of the channel estimation error parameter.

In some examples, to support estimating the channel, the per-tap estimation component 1155 is capable of, configured to, or operable to support a means for estimating, based on the measured delay being greater than the value of the channel estimation error parameter, the channel on a per-tap basis for each tap of a set of taps associated with the FMCW signal, where each tap of the set of taps corresponds to a unique channel delay associated with the FMCW signal.

In some examples, the subband granularity component 1145 is capable of, configured to, or operable to support a means for transmitting a message that indicates a second subband granularity different than the subband granularity, where the control message indicates an adjustment to the subband granularity from the second subband granularity.

In some examples, the subband granularity component 1145 is capable of, configured to, or operable to support a means for communicating in accordance with the subband granularity and the set of one or more channel parameters indicated via the channel estimation report.

In some examples, to support transmitting the channel estimation report, the channel estimation report component 1140 is capable of, configured to, or operable to support a means for transmitting a CSI report that indicates the set of one or more channel parameters.

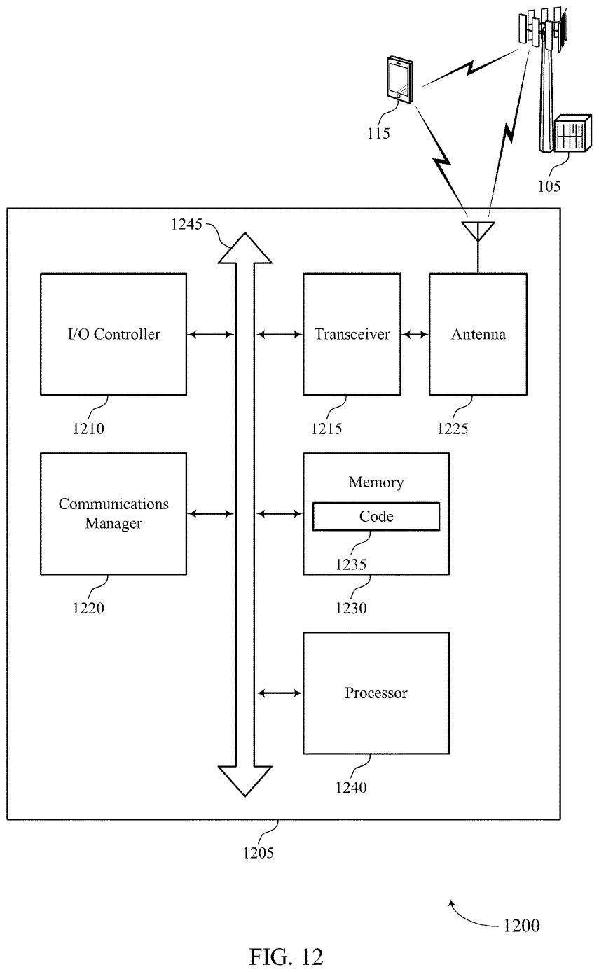

FIG. 12 shows a diagram of a system 1200 including a device 1205 that supports channel granularity for FMCW-based channel estimation in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting channel granularity for FMCW-based channel estimation). For example, the device 1205 or a component of the device 1205 may include a processor 1240 and memory 1230 coupled with or to the processor 1240, the processor 1240 and memory 1230 configured to perform various functions described herein.

Additionally, or alternatively, the communications manager 1220 may support wireless communication at a UE in accordance with examples as disclosed herein. For example, the communications manager 1220 is capable of, configured to, or operable to support a means for receiving a control message including a trigger for an FMCW-based channel estimation procedure. The communications manager 1220 is capable of, configured to, or operable to support a means for receiving, via a channel, an FMCW signal. The communications manager 1220 is capable of, configured to, or operable to support a means for estimating the channel, responsive to the trigger, with a subband granularity as part of the FMCW-based channel estimation procedure, estimation of the channel based on the FMCW signal, a measured delay associated with the channel, and a measured Doppler-based frequency shift associated with the channel. The communications manager 1220 is capable of, configured to, or operable to support a means for transmitting a channel estimation report including a set of one or more channel parameters determined via the estimation of the channel, the channel estimation report associated with the subband granularity.

By including or configuring the communications manager 1220 in accordance with examples as described herein, the device 1205 may support techniques for improved communication reliability, reduced latency, reduced power consumption, more efficient utilization of communication resources, and improved coordination between devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of channel granularity for FMCW-based channel estimation as described herein, or the processor 1240 and the memory 1230 may be otherwise configured to perform or support such operations.

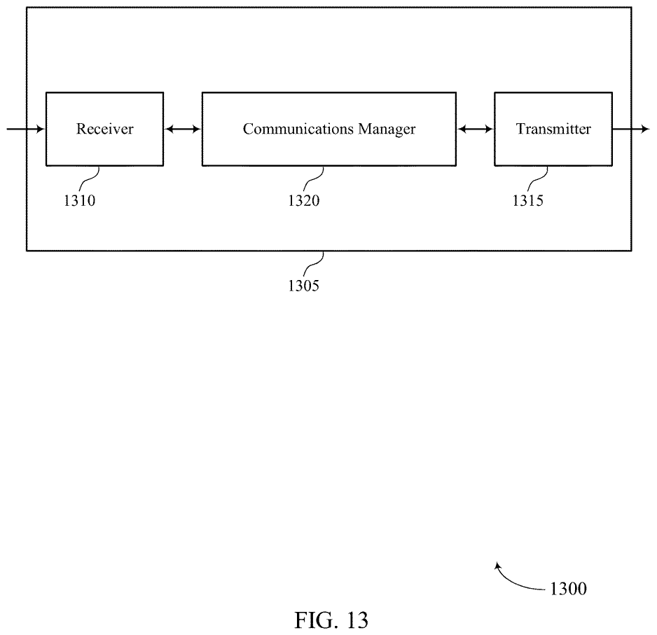

FIG. 13 shows a block diagram 1300 of a device 1305 that supports channel granularity for FMCW-based channel estimation in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of channel granularity for FMCW-based channel estimation as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

Additionally, or alternatively, the communications manager 1320 may support wireless communication at a network entity in accordance with examples as disclosed herein. For example, the communications manager 1320 is capable of, configured to, or operable to support a means for transmitting a control message including a trigger for an FMCW-based channel estimation procedure. The communications manager 1320 is capable of, configured to, or operable to support a means for transmitting, via a channel, an FMCW signal. The communications manager 1320 is capable of, configured to, or operable to support a means for receiving, based on the FMCW-based channel estimation procedure, a channel estimation report including a set of one or more channel parameters, the channel estimation report associated with a subband granularity, where the channel estimation report is based on the FMCW signal, a measured delay associated with the channel, and a measured Doppler-based frequency shift associated with the channel.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for reduced processing, reduced power consumption, and more efficient utilization of communication resources.

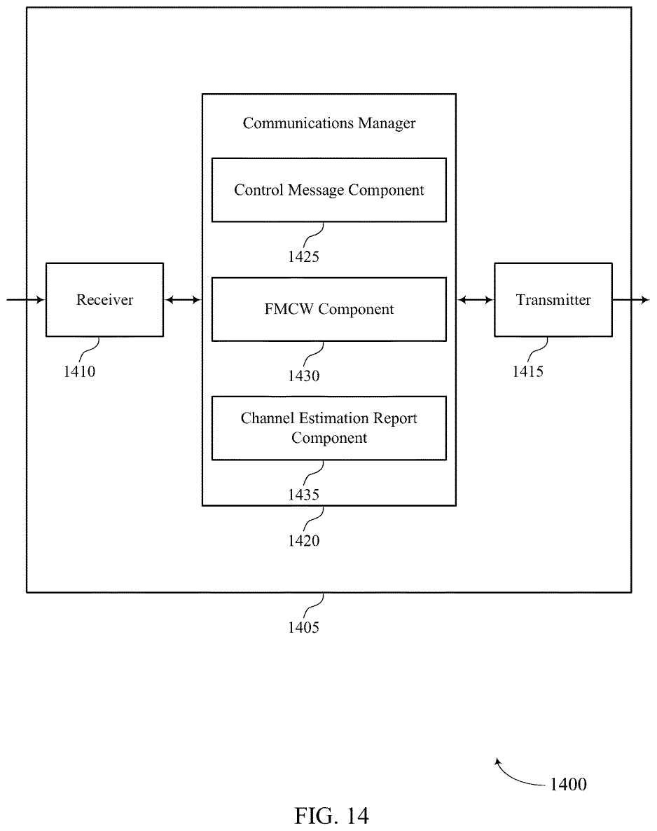

FIG. 14 shows a block diagram 1400 of a device 1405 that supports channel granularity for FMCW-based channel estimation in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of channel granularity for FMCW-based channel estimation as described herein. For example, the communications manager 1420 may include a control message component 1425, an FMCW component 1430, a channel estimation report component 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a network entity in accordance with examples as disclosed herein. The control message component 1425 is capable of, configured to, or operable to support a means for transmitting a control message including a trigger for an FMCW-based channel estimation procedure. The FMCW component 1430 is capable of, configured to, or operable to support a means for transmitting, via a channel, an FMCW signal. The channel estimation report component 1435 is capable of, configured to, or operable to support a means for receiving, based on the FMCW-based channel estimation procedure, a channel estimation report including a set of one or more channel parameters, the channel estimation report associated with a subband granularity, where the channel estimation report is based on the FMCW signal, a measured delay associated with the channel, and a measured Doppler-based frequency shift associated with the channel.

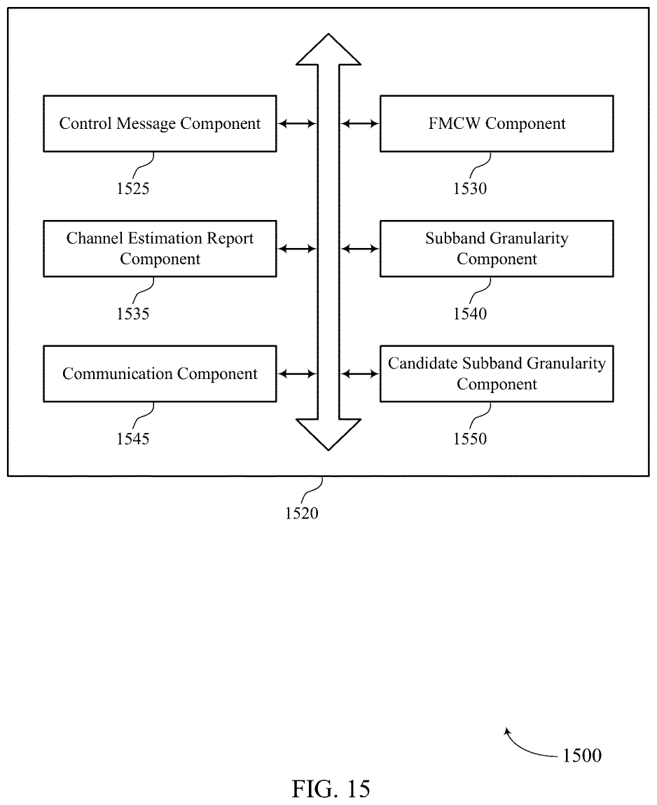

FIG. 15 shows a block diagram 1500 of a communications manager 1520 that supports channel granularity for FMCW-based channel estimation in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of channel granularity for FMCW-based channel estimation as described herein. For example, the communications manager 1520 may include a control message component 1525, an FMCW component 1530, a channel estimation report component 1535, a subband granularity component 1540, a communication component 1545, a candidate subband granularity component 1550, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1520 may support wireless communication at a network entity in accordance with examples as disclosed herein. The control message component 1525 is capable of, configured to, or operable to support a means for transmitting a control message including a trigger for an FMCW-based channel estimation procedure. The FMCW component 1530 is capable of, configured to, or operable to support a means for transmitting, via a channel, an FMCW signal. The channel estimation report component 1535 is capable of, configured to, or operable to support a means for receiving, based on the FMCW-based channel estimation procedure, a channel estimation report including a set of one or more channel parameters, the channel estimation report associated with a subband granularity, where the channel estimation report is based on the FMCW signal, a measured delay associated with the channel, and a measured Doppler-based frequency shift associated with the channel.

In some examples, the subband granularity component 1540 is capable of, configured to, or operable to support a means for receiving, via the channel estimation report, an indication of the subband granularity based on the measured delay and the measured Doppler-based frequency shift.

In some examples, the subband granularity corresponds to a frequency subband size associated with the channel estimation report.

In some examples, the subband granularity corresponds to a quantity of frequency subbands associated with the channel estimation report.

In some examples, the candidate subband granularity component 1550 is capable of, configured to, or operable to support a means for transmitting a control message that indicates a set of candidate subband granularities, where the subband granularity is selected from the set of candidate subband granularities.

In some examples, the candidate subband granularity component 1550 is capable of, configured to, or operable to support a means for transmitting a control message that indicates a set of candidate subband granularities from among a set of multiple defined sets of subband granularities, where the subband granularity is selected from the set of candidate subband granularities.

In some examples, the subband granularity component 1540 is capable of, configured to, or operable to support a means for transmitting a control message that indicates the subband granularity for the FMCW-based channel estimation procedure, where the FMCW-based channel estimation procedure is based on a value of the subband granularity, the measured delay, and the measured Doppler-based frequency shift.

In some examples, the subband granularity component 1540 is capable of, configured to, or operable to support a means for receiving a message that indicates a second subband granularity different than the subband granularity. In some examples, the subband granularity component 1540 is capable of, configured to, or operable to support a means for adjusting the second subband granularity to the subband granularity based on one or more parameters associated with the channel, where the control message indicates the subband granularity based on the adjusting.

In some examples, the communication component 1545 is capable of, configured to, or operable to support a means for communicating in accordance with the subband granularity and the set of one or more channel parameters indicated via the channel estimation report.

In some examples, to support receiving the channel estimation report, the channel estimation report component 1535 is capable of, configured to, or operable to support a means for receiving a CSI report that indicates the set of one or more channel parameters.

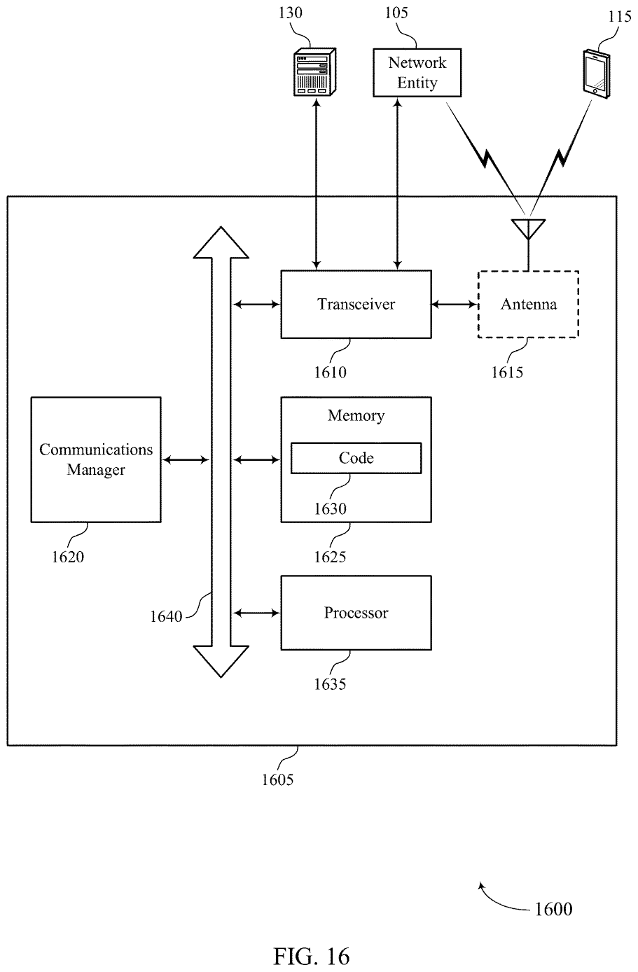

FIG. 16 shows a diagram of a system 1600 including a device 1605 that supports channel granularity for FMCW-based channel estimation in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or memory components (for example, the processor 1635, or the memory 1625, or both), may be included in a chip or chip assembly that is installed in the device 1605. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting channel granularity for FMCW-based channel estimation). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605. The processor 1635 may be any one or more suitable processors capable of executing scripts or instructions of one or more software programs stored in the device 1605 (such as within the memory 1625). In some implementations, the processor 1635 may be a component of a processing system. A processing system may generally refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the processor 1635, or the transceiver 1610, or the communications manager 1620, or other components or combinations of components of the device 1605. The processing system of the device 1605 may interface with other components of the device 1605, and may process information received from other components (such as inputs or signals) or output information to other components. For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem. Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

Additionally, or alternatively, the communications manager 1620 may support wireless communication at a network entity in accordance with examples as disclosed herein. For example, the communications manager 1620 is capable of, configured to, or operable to support a means for transmitting a control message including a trigger for an FMCW-based channel estimation procedure. The communications manager 1620 is capable of, configured to, or operable to support a means for transmitting, via a channel, an FMCW signal. The communications manager 1620 is capable of, configured to, or operable to support a means for receiving, based on the FMCW-based channel estimation procedure, a channel estimation report including a set of one or more channel parameters, the channel estimation report associated with a subband granularity, where the channel estimation report is based on the FMCW signal, a measured delay associated with the channel, and a measured Doppler-based frequency shift associated with the channel.

By including or configuring the communications manager 1620 in accordance with examples as described herein, the device 1605 may support techniques for improved communication reliability, reduced latency, reduced power consumption, more efficient utilization of communication resources, and improved coordination between devices.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, the processor 1635, the memory 1625, the code 1630, or any combination thereof. For example, the code 1630 may include instructions executable by the processor 1635 to cause the device 1605 to perform various aspects of channel granularity for FMCW-based channel estimation as described herein, or the processor 1635 and the memory 1625 may be otherwise configured to perform or support such operations.

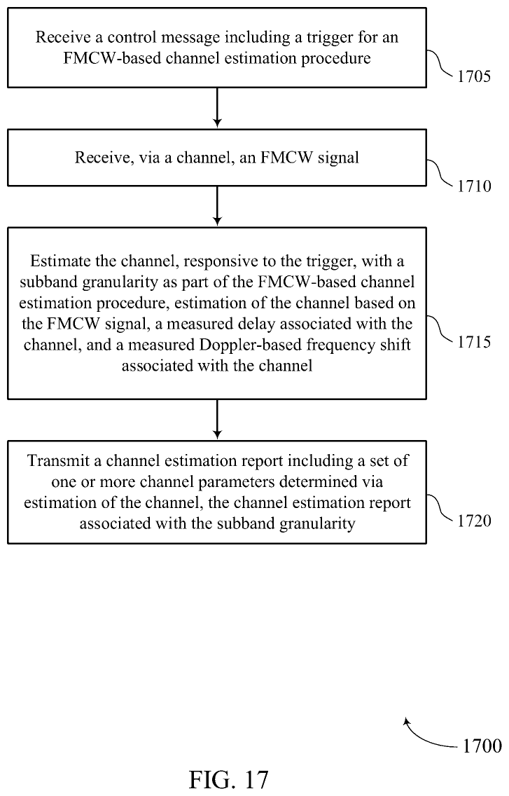

FIG. 17 shows a flowchart illustrating a method 1700 that supports channel granularity for FMCW-based channel estimation in accordance with aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the wireless UE to perform the described functions. Additionally, or alternatively, the wireless UE may perform aspects of the described functions using special-purpose hardware.

At 1705, the method may include receiving a control message including a trigger for an FMCW-based channel estimation procedure. The operations of 1705 may be performed in accordance with examples as disclosed herein. In some examples, aspects of the operations of 1705 may be performed by a control message component 1125 as described with reference to FIG. 11.

At 1710, the method may include receiving, via a channel, an FMCW signal. The operations of 1710 may be performed in accordance with examples as disclosed herein. In some examples, aspects of the operations of 1710 may be performed by an FMCW component 1130 as described with reference to FIG. 11.

At 1715, the method may include estimating the channel, responsive to the trigger, with a subband granularity as part of the FMCW-based channel estimation procedure, estimation of the channel based on the FMCW signal, a measured delay associated with the channel, and a measured Doppler-based frequency shift associated with the channel. The operations of 1715 may be performed in accordance with examples as disclosed herein. In some examples, aspects of the operations of 1715 may be performed by a channel estimation component 1135 as described with reference to FIG. 11.

At 1720, the method may include transmitting a channel estimation report including a set of one or more channel parameters determined via the estimation of the channel, the channel estimation report associated with the subband granularity. The operations of 1720 may be performed in accordance with examples as disclosed herein. In some examples, aspects of the operations of 1720 may be performed by a channel estimation report component 1140 as described with reference to FIG. 11.

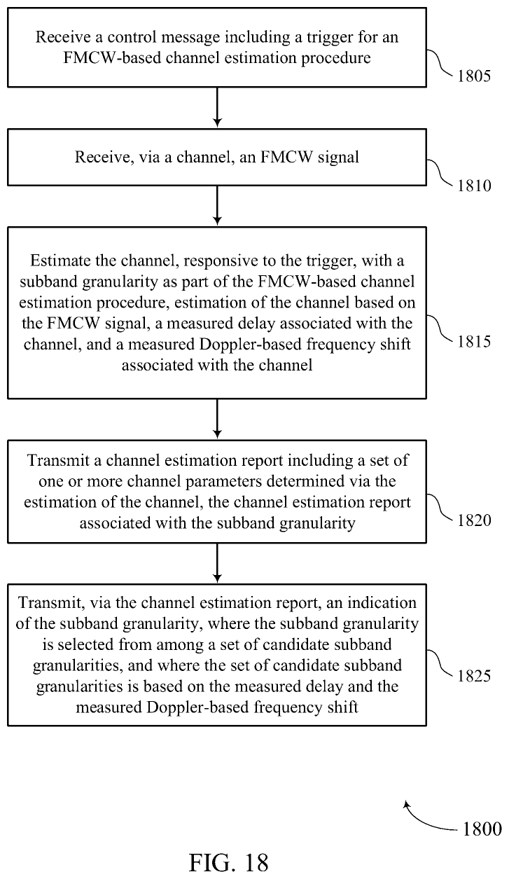

FIG. 18 shows a flowchart illustrating a method 1800 that supports channel granularity for FMCW-based channel estimation in accordance with aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the wireless UE to perform the described functions. Additionally, or alternatively, the wireless UE may perform aspects of the described functions using special-purpose hardware.

At 1805, the method may include receiving a control message including a trigger for an FMCW-based channel estimation procedure. The operations of 1805 may be performed in accordance with examples as disclosed herein. In some examples, aspects of the operations of 1805 may be performed by a control message component 1125 as described with reference to FIG. 11.

At 1810, the method may include receiving, via a channel, an FMCW signal. The operations of 1810 may be performed in accordance with examples as disclosed herein. In some examples, aspects of the operations of 1810 may be performed by an FMCW component 1130 as described with reference to FIG. 11.

At 1815, the method may include estimating the channel, responsive to the trigger, with a subband granularity as part of the FMCW-based channel estimation procedure, estimation of the channel based on the FMCW signal, a measured delay associated with the channel, and a measured Doppler-based frequency shift associated with the channel. The operations of 1815 may be performed in accordance with examples as disclosed herein. In some examples, aspects of the operations of 1815 may be performed by a channel estimation component 1135 as described with reference to FIG. 11.

At 1820, the method may include transmitting a channel estimation report including a set of one or more channel parameters determined via the estimation of the channel, the channel estimation report associated with the subband granularity. The operations of 1820 may be performed in accordance with examples as disclosed herein. In some examples, aspects of the operations of 1820 may be performed by a channel estimation report component 1140 as described with reference to FIG. 11.

At 1825, the method may include transmitting, via the channel estimation report, an indication of the subband granularity, where the subband granularity is selected from among a set of candidate subband granularities, and where the set of candidate subband granularities is based on the measured delay and the measured Doppler-based frequency shift. The operations of 1825 may be performed in accordance with examples as disclosed herein. In some examples, aspects of the operations of 1825 may be performed by a subband granularity component 1145 as described with reference to FIG. 11.

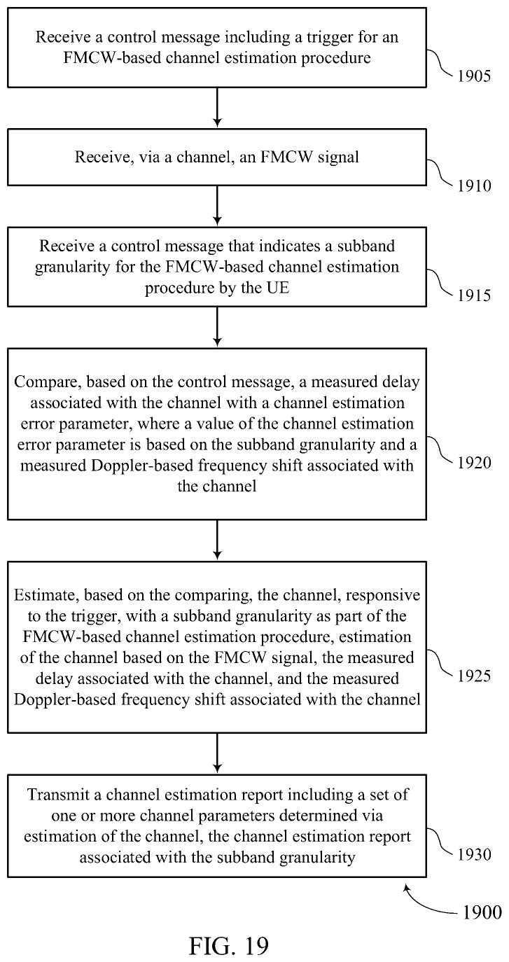

FIG. 19 shows a flowchart illustrating a method 1900 that supports channel granularity for FMCW-based channel estimation in accordance with aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the wireless UE to perform the described functions. Additionally, or alternatively, the wireless UE may perform aspects of the described functions using special-purpose hardware.

At 1905, the method may include receiving a control message including a trigger for an FMCW-based channel estimation procedure. The operations of 1905 may be performed in accordance with examples as disclosed herein. In some examples, aspects of the operations of 1905 may be performed by a control message component 1125 as described with reference to FIG. 11.

At 1910, the method may include receiving, via a channel, an FMCW signal. The operations of 1910 may be performed in accordance with examples as disclosed herein. In some examples, aspects of the operations of 1910 may be performed by an FMCW component 1130 as described with reference to FIG. 11.

At 1915, the method may include receiving a control message that indicates the subband granularity for the FMCW-based channel estimation procedure by the UE. The operations of 1915 may be performed in accordance with examples as disclosed herein. In some examples, aspects of the operations of 1915 may be performed by a control message component 1125 as described with reference to FIG. 11.

At 1920, the method may include comparing, based on the control message, a measured delay associated with the channel with a channel estimation error parameter, where a value of the channel estimation error parameter is based on the subband granularity and a measured Doppler-based frequency shift associated with the channel. The operations of 1920 may be performed in accordance with examples as disclosed herein. In some examples, aspects of the operations of 1920 may be performed by an estimation error component 1150 as described with reference to FIG. 11.

At 1925, the method may include estimating, based on the comparing, the channel, responsive to the trigger, with a subband granularity as part of the FMCW-based channel estimation procedure, estimation of the channel based on the FMCW signal, the measured delay associated with the channel, and the measured Doppler-based frequency shift associated with the channel. The operations of 1925 may be performed in accordance with examples as disclosed herein. In some examples, aspects of the operations of 1925 may be performed by a channel estimation component 1135 as described with reference to FIG. 11.

At 1930, the method may include transmitting a channel estimation report including a set of one or more channel parameters determined via the estimation of the channel, the channel estimation report associated with the subband granularity. The operations of 1930 may be performed in accordance with examples as disclosed herein. In some examples, aspects of the operations of 1930 may be performed by a channel estimation report component 1140 as described with reference to FIG. 11.

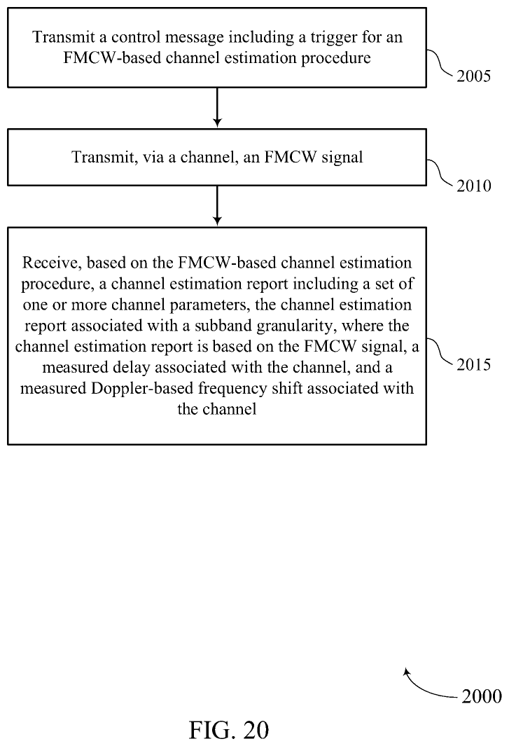

FIG. 20 shows a flowchart illustrating a method 2000 that supports channel granularity for FMCW-based channel estimation in accordance with aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the wireless network entity to perform the described functions. Additionally, or alternatively, the wireless network entity may perform aspects of the described functions using special-purpose hardware.

At 2005, the method may include transmitting a control message including a trigger for an FMCW-based channel estimation procedure. The operations of 2005 may be performed in accordance with examples as disclosed herein. In some examples, aspects of the operations of 2005 may be performed by a control message component 1525 as described with reference to FIG. 15.

At 2010, the method may include transmitting, via a channel, an FMCW signal. The operations of 2010 may be performed in accordance with examples as disclosed herein. In some examples, aspects of the operations of 2010 may be performed by an FMCW component 1530 as described with reference to FIG. 15.

At 2015, the method may include receiving, based on the FMCW-based channel estimation procedure, a channel estimation report including a set of one or more channel parameters, the channel estimation report associated with a subband granularity, where the channel estimation report is based on the FMCW signal, a measured delay associated with the channel, and a measured Doppler-based frequency shift associated with the channel. The operations of 2015 may be performed in accordance with examples as disclosed herein. In some examples, aspects of the operations of 2015 may be performed by a channel estimation report component 1535 as described with reference to FIG. 15.

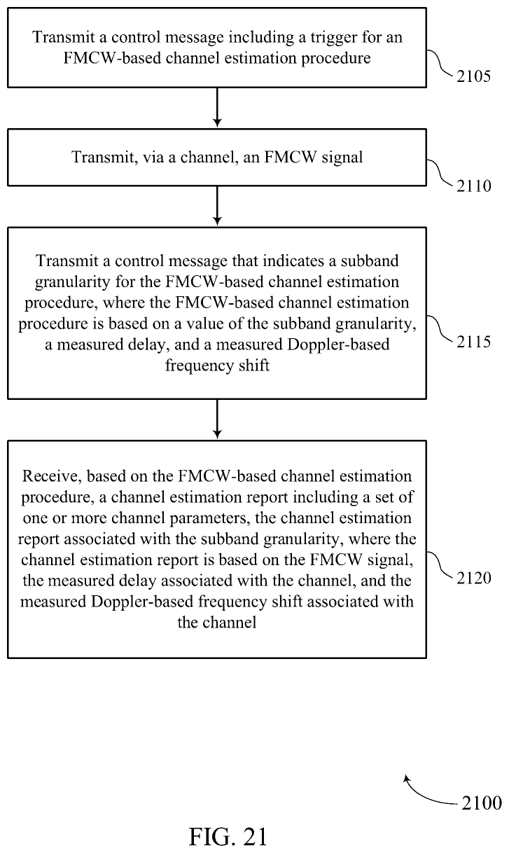

FIG. 21 shows a flowchart illustrating a method 2100 that supports channel granularity for FMCW-based channel estimation in accordance with aspects of the present disclosure. The operations of the method 2100 may be implemented by a network entity or its components as described herein. For example, the operations of the method 2100 may be performed by a network entity as described with reference to FIGS. 1 through 8 and 13 through 16. In some examples, a network entity may execute a set of instructions to control the functional elements of the wireless network entity to perform the described functions. Additionally, or alternatively, the wireless network entity may perform aspects of the described functions using special-purpose hardware.

At 2105, the method may include transmitting a control message including a trigger for an FMCW-based channel estimation procedure. The operations of 2105 may be performed in accordance with examples as disclosed herein. In some examples, aspects of the operations of 2105 may be performed by a control message component 1525 as described with reference to FIG. 15.

At 2110, the method may include transmitting, via a channel, an FMCW signal. The operations of 2110 may be performed in accordance with examples as disclosed herein. In some examples, aspects of the operations of 2110 may be performed by an FMCW component 1530 as described with reference to FIG. 15.

At 2115, the method may include transmitting a control message that indicates a subband granularity for the FMCW-based channel estimation procedure, where the FMCW-based channel estimation procedure is based on a value of the subband granularity, a measured delay, and a measured Doppler-based frequency shift. The operations of 2115 may be performed in accordance with examples as disclosed herein. In some examples, aspects of the operations of 2115 may be performed by a subband granularity component 1540 as described with reference to FIG. 15.

At 2120, the method may include receiving, based on the FMCW-based channel estimation procedure, a channel estimation report including a set of one or more channel parameters, the channel estimation report associated with the subband granularity, where the channel estimation report is based on the FMCW signal, the measured delay associated with the channel, and the measured Doppler-based frequency shift associated with the channel. The operations of 2120 may be performed in accordance with examples as disclosed herein. In some examples, aspects of the operations of 2120 may be performed by a channel estimation report component 1535 as described with reference to FIG. 15.

The following provides an overview of aspects of the present disclosure:
Aspect 1: A method for wireless communication at a UE, comprising: receiving a control message comprising a trigger for a FMCW-based channel estimation procedure by the UE; receiving, via a channel and based at least in part on the trigger, a FMCW signal; estimating the channel, responsive to the trigger, with a subband granularity as part of the FMCW-based channel estimation procedure, estimation of the channel based at least in part on the FMCW signal, a measured delay associated with the channel, and a measured Doppler-based frequency shift associated with the channel; and transmitting, based at least in part on the estimation of the channel, a channel estimation report comprising a set of one or more channel parameters determined via the estimation of the channel, the channel estimation report associated with the subband granularity.
Aspect 2: The method of aspect 1, further comprising: transmitting, via the channel estimation report, an indication of the subband granularity, wherein the subband granularity is selected from among a set of candidate subband granularities, and wherein the set of candidate subband granularities is based at least in part on the measured delay and the measured Doppler-based frequency shift.
Aspect 3: The method of aspect 2, further comprising: calculating a threshold subband size based at least in part on a function of the measured delay and the measured Doppler-based frequency shift, wherein the subband granularity corresponds to a frequency subband size associated with the channel estimation report, and wherein the set of candidate subband granularities comprises frequency subband sizes that are greater than or equal to the threshold subband size.
Aspect 4: The method of aspect 2, further comprising: calculating a threshold quantity of subbands based at least in part on a function of the measured delay and the measured Doppler-based frequency shift, wherein the subband granularity corresponds to a quantity of frequency subbands associated with the channel estimation report, and wherein the set of candidate subband granularities comprises quantities of frequency subbands that are less than or equal to the threshold quantity.
Aspect 5: The method of any of aspects 2 through 4, further comprising: receiving a control message that indicates the set of candidate subband granularities.
Aspect 6: The method of any of aspects 2 through 5, further comprising: receiving a control message that indicates the set of candidate subband granularities from among a plurality of defined sets of subband granularities.
Aspect 7: The method of aspect 1, further comprising: receiving a control message that indicates the subband granularity for the FMCW-based channel estimation procedure by the UE; and comparing, based at least in part on the control message, the measured delay associated with the channel with a channel estimation error parameter, wherein a value of the channel estimation error parameter is based at least in part on the subband granularity and the measured Doppler-based frequency shift associated with the channel, and wherein estimating the channel is based at least in part on the comparing.
Aspect 8: The method of aspect 7, wherein estimating the channel comprises: estimating the channel in accordance with a sampling rate based at least in part on the measured delay being less than or equal to the value of the channel estimation error parameter.
Aspect 9: The method of aspect 7, wherein estimating the channel comprises: estimating, based at least in part on the measured delay being greater than the value of the channel estimation error parameter, the channel on a per-tap basis for each tap of a set of taps associated with the FMCW signal, wherein each tap of the set of taps corresponds to a unique channel delay associated with the FMCW signal.
Aspect 10: The method of any of aspects 7 through 9, further comprising: transmitting a message that indicates a second subband granularity different than the subband granularity, wherein the control message indicates an adjustment to the subband granularity from the second subband granularity.
Aspect 11: The method of any of aspects 1 through 10, further comprising: communicating in accordance with the subband granularity and the set of one or more channel parameters indicated via the channel estimation report.
Aspect 12: The method of any of aspects 1 through 11, wherein transmitting the channel estimation report comprises: transmitting a CSI report that indicates the set of one or more channel parameters.
Aspect 13: A method for wireless communication at a network entity, comprising: transmitting a control message comprising a trigger for a FMCW-based channel estimation procedure; transmitting, via a channel, a FMCW signal; and receiving, based at least in part on the FMCW-based channel estimation procedure, a channel estimation report comprising a set of one or more channel parameters, the channel estimation report associated with a subband granularity, wherein the channel estimation report is based at least in part on the FMCW signal, a measured delay associated with the channel, and a measured Doppler-based frequency shift associated with the channel.
Aspect 14: The method of aspect 13, further comprising: receiving, via the channel estimation report, an indication of the subband granularity based at least in part on the measured delay and the measured Doppler-based frequency shift.
Aspect 15: The method of aspect 14, wherein the subband granularity corresponds to a frequency subband size associated with the channel estimation report.
Aspect 16: The method of aspect 14, wherein the subband granularity corresponds to a quantity of frequency subbands associated with the channel estimation report.
Aspect 17: The method of any of aspects 14 through 16, further comprising: transmitting a control message that indicates a set of candidate subband granularities, wherein the subband granularity is selected from the set of candidate subband granularities.
Aspect 18: The method of any of aspects 14 through 17, further comprising: transmitting a control message that indicates a set of candidate subband granularities from among a plurality of defined sets of subband granularities, wherein the subband granularity is selected from the set of candidate subband granularities.
Aspect 19: The method of aspect 13, further comprising: transmitting a control message that indicates the subband granularity for the FMCW-based channel estimation procedure, wherein the FMCW-based channel estimation procedure is based at least in part on a value of the subband granularity, the measured delay, and the measured Doppler-based frequency shift.
Aspect 20: The method of aspect 19, further comprising: receiving a message that indicates a second subband granularity different than the subband granularity; and adjusting the second subband granularity to the subband granularity based at least in part on one or more parameters associated with the channel, wherein the control message indicates the subband granularity based at least in part on the adjusting.
Aspect 21: The method of any of aspects 13 through 20, further comprising: communicating in accordance with the subband granularity and the set of one or more channel parameters indicated via the channel estimation report.
Aspect 22: The method of any of aspects 13 through 21, wherein receiving the channel estimation report comprises: receiving a CSI report that indicates the set of one or more channel parameters.
Aspect 23: An apparatus for wireless communication at a UE, comprising a processor; memory coupled with the processor; and instructions stored in the memory and executable by the processor to cause the apparatus to perform a method of any of aspects 1 through 12.
Aspect 24: An apparatus for wireless communication at a UE, comprising at least one means for performing a method of any of aspects 1 through 12.
Aspect 25: A non-transitory computer-readable medium storing code for wireless communication at a UE, the code comprising instructions executable by a processor to perform a method of any of aspects 1 through 12.
Aspect 26: An apparatus for wireless communication at a network entity, comprising a processor; memory coupled with the processor; and instructions stored in the memory and executable by the processor to cause the apparatus to perform a method of any of aspects 13 through 22.
Aspect 27: An apparatus for wireless communication at a network entity, comprising at least one means for performing a method of any of aspects 13 through 22.
Aspect 28: A non-transitory computer-readable medium storing code for wireless communication at a network entity, the code comprising instructions executable by a processor to perform a method of any of aspects 13 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE), comprising:
a processor;
memory coupled with the processor; and
instructions stored in the memory and executable by the processor to cause the UE to:
receive a control message comprising a trigger for a frequency modulated continuous waveform-based channel estimation procedure;
receive, via a channel, a frequency modulated continuous waveform signal;
estimate the channel, responsive to the trigger, with a subband granularity as part of the frequency modulated continuous waveform-based channel estimation procedure, estimation of the channel based at least in part on the frequency modulated continuous waveform signal, a measured delay associated with the channel, and a measured Doppler-based frequency shift associated with the channel; and
transmit a channel estimation report comprising a set of one or more channel parameters determined via the estimation of the channel, the channel estimation report associated with the subband granularity.

2. The UE of claim 1, wherein the instructions are further executable by the processor to cause the UE to:
transmit, via the channel estimation report, an indication of the subband granularity, wherein the subband granularity is selected from among a set of candidate subband granularities, and wherein the set of candidate subband granularities is based at least in part on the measured delay and the measured Doppler-based frequency shift.

3. The UE of claim 2, wherein the instructions are further executable by the processor to cause the UE to:
calculate a threshold subband size based at least in part on a function of the measured delay and the measured Doppler-based frequency shift, wherein the subband granularity corresponds to a frequency subband size associated with the channel estimation report, and wherein the set of candidate subband granularities comprises frequency subband sizes that are greater than or equal to the threshold subband size.

4. The UE of claim 2, wherein the instructions are further executable by the processor to cause the UE to:
calculate a threshold quantity of subbands based at least in part on a function of the measured delay and the measured Doppler-based frequency shift, wherein the subband granularity corresponds to a quantity of frequency subbands associated with the channel estimation report, and wherein the set of candidate subband granularities comprises quantities of frequency subbands that are less than or equal to the threshold quantity.

5. The UE of claim 2, wherein the instructions are further executable by the processor to cause the UE to:
receive a control message that indicates the set of candidate subband granularities.

6. The UE of claim 2, wherein the instructions are further executable by the processor to cause the UE to:
receive a control message that indicates the set of candidate subband granularities from among a plurality of defined sets of subband granularities.

7. The UE of claim 1, wherein the instructions are further executable by the processor to cause the UE to:
receive a control message that indicates the subband granularity for the frequency modulated continuous waveform-based channel estimation procedure by the UE; and
compare, based at least in part on the control message, the measured delay associated with the channel with a channel estimation error parameter, wherein a value of the channel estimation error parameter is based at least in part on the subband granularity and the measured Doppler-based frequency shift associated with the channel, and wherein estimating the channel is based at least in part on the comparing.

8. The UE of claim 7, wherein the instructions to estimate the channel are executable by the processor to cause the UE to:
estimate the channel in accordance with a sampling rate based at least in part on the measured delay being less than or equal to the value of the channel estimation error parameter.

9. The UE of claim 7, wherein the instructions to estimate the channel are executable by the processor to cause the UE to:
estimate, based at least in part on the measured delay being greater than the value of the channel estimation error parameter, the channel on a per-tap basis for each tap of a set of taps associated with the frequency modulated continuous waveform signal, wherein each tap of the set of taps corresponds to a unique channel delay associated with the frequency modulated continuous waveform signal.

10. The UE of claim 7, wherein the instructions are further executable by the processor to cause the UE to:
transmit a message that indicates a second subband granularity different than the subband granularity, wherein the control message indicates an adjustment to the subband granularity from the second subband granularity.

11. The UE of claim 1, wherein the instructions are further executable by the processor to cause the UE to:
communicate in accordance with the subband granularity and the set of one or more channel parameters indicated via the channel estimation report.

12. The UE of claim 1, wherein the instructions to transmit the channel estimation report are executable by the processor to cause the UE to:
transmit a channel state information report that indicates the set of one or more channel parameters.

13. A network entity, comprising:
a processor;
memory coupled with the processor; and
instructions stored in the memory and executable by the processor to cause the network entity to:
transmit a control message comprising a trigger for a frequency modulated continuous waveform-based channel estimation procedure;
transmit, via a channel, a frequency modulated continuous waveform signal; and
receive, based at least in part on the frequency modulated continuous waveform-based channel estimation procedure, a channel estimation report comprising a set of one or more channel parameters, the channel estimation report associated with a subband granularity, wherein the channel estimation report is based at least in part on the frequency modulated continuous waveform signal, a measured delay associated with the channel, and a measured Doppler-based frequency shift associated with the channel.

14. The network entity of claim 13, wherein the instructions are further executable by the processor to cause the network entity to:
receive, via the channel estimation report, an indication of the subband granularity based at least in part on the measured delay and the measured Doppler-based frequency shift.

15-16. (canceled)

17. The network entity of claim 14, wherein the instructions are further executable by the processor to cause the network entity to:
transmit a control message that indicates a set of candidate subband granularities, wherein the subband granularity is selected from the set of candidate subband granularities.

18. The network entity of claim 14, wherein the instructions are further executable by the processor to cause the network entity to:
transmit a control message that indicates a set of candidate subband granularities from among a plurality of defined sets of subband granularities, wherein the subband granularity is selected from the set of candidate subband granularities.

19. The network entity of claim 13, wherein the instructions are further executable by the processor to cause the network entity to:
transmit a control message that indicates the subband granularity for the frequency modulated continuous waveform-based channel estimation procedure, wherein the frequency modulated continuous waveform-based channel estimation procedure is based at least in part on a value of the subband granularity, the measured delay, and the measured Doppler-based frequency shift.

20. The network entity of claim 19, wherein the instructions are further executable by the processor to cause the network entity to:
receive a message that indicates a second subband granularity different than the subband granularity; and
adjust the second subband granularity to the subband granularity based at least in part on one or more parameters associated with the channel, wherein the control message indicates the subband granularity based at least in part on the adjusting.

21-22. (canceled)

23. A method for wireless communication at a user equipment (UE), comprising:
receiving a control message comprising a trigger for a frequency modulated continuous waveform-based channel estimation procedure;
receiving, via a channel, a frequency modulated continuous waveform signal;
estimating the channel, responsive to the trigger, with a subband granularity as part of the frequency modulated continuous waveform-based channel estimation procedure, estimation of the channel based at least in part on the frequency modulated continuous waveform signal, a measured delay associated with the channel, and a measured Doppler-based frequency shift associated with the channel; and
transmitting a channel estimation report comprising a set of one or more channel parameters determined via the estimation of the channel, the channel estimation report associated with the subband granularity.

24. The method of claim 23, further comprising:
transmitting, via the channel estimation report, an indication of the subband granularity, wherein the subband granularity is selected from among a set of candidate subband granularities, and wherein the set of candidate subband granularities is based at least in part on the measured delay and the measured Doppler-based frequency shift.

25-30. (canceled)
